(19) United States
(12) Patent Application Publication
(10) Pub. No.: US 2013/0053465 A1
(43) Pub. Date: Feb. 28, 2013

(54) ETHYLENE/ALPHA-OLEFIN COPOLYMER FOR FOAM PRODUCTION, RESIN COMPOSITION FOR FOAM PRODUCTION, AND METHOD FOR PRODUCING FOAM

(71) Applicants: Toshihiko Manami, Chiba (JP); Yoshinobu Nozue, Chiba (JP)

(72) Inventors: Toshihiko Manami, Chiba (JP); Yoshinobu Nozue, Chiba (JP)

(73) Assignee: SUMITOMO CHEMICAL COMPANY, LIMITED, Tokyo (JP)

(21) Appl. No.: 13/642,377

(22) PCT Filed: Apr. 19, 2011
(86) PCT No.: PCT/JP2011/060000

§ 371 Date: Nov. 8, 2012

(30) Foreign Application Priority Data
Apr. 20, 2010 (JP) 2010-096731

(51) Int. Cl. C08F 10/02; C08L 23/26; C08L 23/08

(52) U.S. Cl. 521/144; 526/348

(57) ABSTRACT

The ethylene-α-olefin copolymer contains monomer units derived from ethylene and monomer units derived from an α-olefin having 3 to 20 carbon atoms for producing a foam. The ethylene-α-olefin copolymer has a melt flow rate of 0.1 to 100 g/10 minutes, a density of 850 to 940 kg/m³, a molecular weight distribution of 2 to 12, a swell ratio of 1.61 or more, and a value of g* as defined by a formula (I) of 0.50 to 0.78.

### TECHNICAL FIELD

The present invention relates to an ethylene-α-olefin copolymer for producing a foam, a resin composition for producing a foam, and a method for producing a foam.

### BACKGROUND ART

Since a foam comprising an ethylene-α-olefin copolymer is excellent in flexibility and a heat insulating property, it is used in a variety of uses such as buffer materials or heat insulating materials, convenience goods, floor materials, sound insulation materials, members for footwear (outersoles (lower bottoms), midsoles (upper bottoms), insoles (sock liners) etc.).

As one of ethylene-α-olefin copolymers, an ethylene-α-olefin copolymer obtained by polymerizing ethylene and an α-olefin using a metallocene catalyst is known. Such an ethylene-α-olefin copolymer is excellent in mechanical strength such as impact strength or tensile strength.

JP-A-2008-1792 describes a method of irradiating a resin composition comprising an ethylene-α-olefin copolymer obtained by polymerizing ethylene and an α-olefin using a metallocene catalyst, and a thermally decomposable foaming agent, with ionizing radiation to obtain a cross-linked resin composition, and heating the cross-linked resin composition to obtain a cross-linked foam.

JP-A-2005-314638 describes a cross-linked foam obtained by using a resin composition comprising an ethylene-α-olefin copolymer obtained by polymerizing ethylene and an α-olefin using a metallocene catalyst, a thermally decomposable foaming agent and an organic peroxide.

However, the cross-linked foam obtained by the method described in JP-A-2008-1792 is required to have further improvement in a balance between an expansion ratio and strength.

The cross-linked foam described in JP-A-2005-314638 is required to have further improvement in a balance between a lightweight property and fatigue resistance.

Thus, performance which is required to be improved is different, depending on methods for producing a foam.

### DISCLOSURE OF THE INVENTION

Under such circumstances, a problem to be solved by the present invention is to provide an ethylene-α-olefin copolymer for producing a foam and a resin composition for producing a foam, which can be preferably used in a variety of methods for producing foams.

First, the present invention is directed to an ethylene-α-olefin copolymer comprising monomer units derived from ethylene and monomer units derived from an α-olefin having 3 to 20 carbon atoms for producing a foam, wherein the ethylene-α-olefin copolymer has a melt flow rate of 0.1 to 100 g/10 minutes, a density of 850 to 940 kg/m³, a molecular weight distribution of 2 to 12, a swell ratio of 1.61 or more, and a value of g* defined by the following formula (I) of 0.50 to 0.78:

g*=[η]/([η]_{GPC}×g_{SCB}*) (I)

wherein [η] is the intrinsic viscosity (in dl/g) of the ethylene-α-olefin copolymer and is defined by the following formula (I-I), [η]_{GPC} is defined by the following formula (I-II), and g_{SCB}* is defined by the following formula (I-III):

[η]=23.3×log(ηrel) (I-I)

wherein ηrel is the relative viscosity of the ethylene-α-olefin copolymer,

[η]_{GPC}=0.00046×Mv^{0.725} (I-II)

wherein Mv is the viscosity average molecular weight of the ethylene-α-olefin copolymer,

g_{SCB}*=(1−A)^{1.725} (I-III)

wherein A is determined from the content of short branches in the ethylene-α-olefin copolymer.

Second, the present invention is directed to a resin composition for producing a foam, wherein the resin composition comprises 100 parts by weight of a resin material comprising the above ethylene-α-olefin copolymer and 1 to 80 parts by weight, relative to 100 parts by weight of the resin material, of a thermally decomposable foaming agent, wherein the thermally decomposable foaming agent has a decomposition temperature of 120 to 240° C.

Third, the present invention is directed to the above resin composition, wherein the resin composition further comprises 0.02 to 3 parts by weight, relative to 100 parts by weight of the resin material, of an organic peroxide.

Forth, the present invention is directed to a method for producing a cross-linked foam, wherein the method comprises the following steps:

a step of applying ionizing radiation to the above resin composition to form a cross-linked intermediate (i), and

a step of expanding the cross-linked intermediate (i) by heating the cross-linked intermediate (i) to form a cross-linked foam.

Fifth, the present invention is directed to a method for producing a cross-linked foam, wherein the method comprises the following steps:

a step of feeding the above resin composition into a mold,

a step of pressurizing and heating the resin composition in the mold to form a plasticized and cross-linked intermediate (ii), and a step of expanding the intermediate (ii) by opening the mold to form a cross-linked foam.

Sixth, the present invention is directed to a method for producing a cross-linked foam, wherein the method comprises the following steps:

a step of pressurizing and heating the above resin composition to form a plasticized intermediate (iii),

a step of feeding the plasticized intermediate (iii) into a mold and cross-linking the intermediate (iii) by pressurizing and heating the intermediate (iii) in the mold to form a plasticized and cross-linked intermediate (iv), and

a step of expanding the intermediate (iv) by opening the mold to form a cross-linked foam.

### MODE FOR CARRYING OUT THE INVENTION

The ethylene-α-olefin copolymer producing a foam of the present invention is an ethylene-α-olefin copolymer comprising monomer units derived from ethylene and monomer units derived from the α-olefin having 3 to 20 carbon atoms. Examples of the α-olefin include propylene, 1-butene, 1-pentene, 1-hexene, 1-heptene, 1-octene, 1-nonene, 1-decene, 1-dodecene, 4-methyl-1-pentene and 4-methyl-1-hexene. They may be used singly or in combination of two or more kinds. The α-olefin is preferably 1-butene, 1-hexene, 4-methyl-1-pentene or 1-octene.

In addition to monomer units derived from ethylene and monomer units derived from the α-olefin having 3 to 20 carbon atoms, the ethylene-α-olefin copolymer of the present invention may contain monomer units derived from another monomer as far as the effect of the present invention is not impaired. Examples of another monomer include a conjugated diene such as butadiene and isoprene; a non-conjugated diene such as 1,4-pentadiene; an unsaturated carboxylic acid such as acrylic acid and methacrylic acid; an unsaturated carboxylic acid ester such as methyl acrylate, ethyl acrylate, methyl methacrylate and ethyl methacrylate; a vinyl ester such as vinyl acetate; and the like.

A content of the monomer units derived from ethylene in the ethylene-α-olefin copolymer of the present invention is usually from 50 to 99.5% by weight, assuming that the total weight of the ethylene-α-olefin copolymer is 100% by weight. A content of the monomer units derived from an α-olefin is usually from 0.5 to 50% by weight, assuming that the total weight of the ethylene-α-olefin copolymer is 100% by weight.

The ethylene-α-olefin copolymer of the present invention is preferably a copolymer comprising monomer units derived from ethylene and monomer units derived from an α-olefin having 4 to 20 carbon atoms, more preferably a copolymer comprising monomer units derived from ethylene and monomer units derived from an α-olefin having 5 to 20 carbon atoms, and further preferably a copolymer comprising monomer units derived from ethylene and monomer units derived from an α-olefin having 6 to 8 carbon atoms. The copolymer obtained by copolymerizing the monomer units derived from ethylene and the α-olefin having a small carbon atom number may have a large amount of a tacky component without lowering its density. An amount of the tacky component in the copolymer can be quantified by a method of measuring an amount of components which are dissolved in cold xylene when the copolymer is dissolved in the xylene, or the like. An amount of the components which are contained in the copolymer and are dissolved in cold xylene is referred to as CXS.

Examples of the ethylene-α-olefin copolymer of the present invention include an ethylene-1-butene copolymer, an ethylene-1-hexene copolymer, an ethylene-4-methyl-1-pentene copolymer, an ethylene-1-octene copolymer, an ethylene-1-butene-1-hexene copolymer, an ethylene-1-butene-4-methyl-1-pentene copolymer, an ethylene-1-butene-1-octene copolymer and an ethylene-1-hexene-1-octene copolymer. The ethylene-α-olefin copolymer is preferably an ethylene-1-hexene copolymer, an ethylene-4-methyl-1-penetene copolymer, an ethylene-1-butene-1-hexene copolymer, an ethylene-1-butene-1-octene copolymer or an ethylene-1-hexene-1-octene copolymer.

A melt flow rate (hereinafter, may be described as MFR) of the ethylene-α-olefin copolymer of the present invention is from 0.1 to 100 g/10 minutes. The melt flow rate is preferably 0.2 g/10 minutes or more from the viewpoint of enhancing processability, particularly from the viewpoint of reducing a load applied to an extruder when the copolymer is extruded. Further, from the view point of enhancing mechanical strength of obtained foams, the MFR is preferably 50 g/10 minutes or less, more preferably 25 g/10 minutes or less, and further preferably 20 g/10 minutes or less. The melt flow rate is measured with the A method under a load of 21.18 N at a temperature of 190° C. in a method defined by JIS K7210-1995. In measurement of the melt flow rate, the ethylene-α-olefin copolymer compounded with about 1000 ppm of an antioxidant in advance is usually used. The melt flow rate of the ethylene-α-olefin copolymer can be changed, for example, by adjusting a hydrogen concentration or a polymerization temperature in a method for producing an ethylene-α-olefin copolymer described later, and as the hydrogen concentration or the polymerization temperature grows higher, the melt flow rate of the resulting ethylene-α-olefin copolymer becomes greater.

A density (hereinafter, may be described as d) of the ethylene-α-olefin copolymer of the present invention is 850 to 940 kg/m³. The density is preferably 930 kg/m³ or less from the viewpoint of enhancing impact strength among mechanical strength of the resulting foam. From the viewpoint of enhancing tensile strength among mechanical strength of the resulting foam, the density is preferably 870 kg/m³ or more, more preferably 880 kg/m³ or more, further preferably 890 kg/m³ or more, and particularly preferably 900 kg/m³ or more. The density is a value obtained by annealing a sample described in JIS K6760-1995 and, thereafter, measuring the sample in accordance with the method defined in the A method of JIS K7112-1980. The density of the ethylene-α-olefin copolymer can be changed by adjusting a content of the monomer units derived from ethylene in the ethylene-α-olefin copolymer.

A ratio of a weight average molecular weight (hereinafter, may be described as Mw) and a number average molecular weight (hereinafter, may be described as Mn) of the ethylene-α-olefin copolymer of the present invention (hereinafter, may be described as Mw/Mn), namely, an average molecular weight is 2 to 12. If the Mw/Mn is too small, a load applied to an extruder when the copolymer is extruded may become high. The Mw/Mn is preferably 2.5 or more, more preferably 3 or more, further preferably 3.5 or more, further more preferably 4 or more, and most preferably 5 or more. If the Mw/Mn is too large, the mechanical strength of the resulting foam may become low, or an amount of a low-molecular component in the copolymer which becomes one cause of tackiness of a foam may become large. The Mw/Mn is preferably 10 or less, more preferably 8 or less, and further preferably 6.5 or less. A molecular weight distribution can be controlled by adjusting various polymerization conditions. For example, the molecular weight distribution can be controlled by changing a polymerization temperature. In addition, the molecular weight distribution can be also controlled by adjusting a hydrogen concentration in a feed gas to adjust a difference between a hydrogen concentration in the system at the time of polymerization initiation and a hydrogen concentration in the system at the time of polymerization termination.

The weight average molecular weight (Mw) and the number average molecular weight (Mn) are measured by a gel permeation chromatography (GPC) method. The Mw/Mn is a value obtained by dividing Mw by Mn. Examples of measurement conditions of the GPC method are described as follows:

(1) Apparatus: Waters 150C, manufactured by Waters, Inc.

(2) Separation column: TOSOH TSKgelGMH6-HT

(3) Measurement temperature: 140° C.

(4) Carrier: ortho-dichlorobenzene

(5) Flow rate: 1.0 ml/minute

(6) Injected volume: 500 μl

(7) Detector: Differential refractometer

(8) Standard substance for molecular weight: Standard polystyrene

The ethylene-α-olefin copolymer of the present invention has a value of g* defined by the following formula (I) of 0.50 to 0.78. The value of g* is calculated by reference to the following literature: Th. G. Scholte, Developments in Polymer Characterisation-4, J. V. Dawkins Ed., Applied Science, London, 1983, Chapter I, Characterization of Long Chain Branching in Polymers.

g*=[η]/([η]_{GPC}×g_{SCB}*) (I)

wherein [η] is the intrinsic viscosity (in dl/g) of the ethylene-α-olefin copolymer and is defined by the following formula (I-I), [η]_{GPC} is defined by the following formula (I-II), and g_{SCB}* is defined by the following formula (I-III):

[η]=23.3×log(ηrel) (I-I)

wherein ηrel is the relative viscosity of the ethylene-α-olefin copolymer,

η_{GPC}=0.00046×Mv⁷²⁵ (I-II)

wherein Mv is the viscosity average molecular weight of the ethylene-α-olefin copolymer,

g_{SCB}*=(1−A)^{1.725} (I-III)

wherein A is determined from the content of short branches in the ethylene-α-olefin copolymer.

[η]_{GPC} represents the intrinsic viscosity (in dl/g) of an ethylene polymer assuming that the polymer has the same molecular weight distribution as a molecular weight distribution of an ethylene-α-olefin copolymer for which g* is measured, and has a linear molecular chain.

g_{SCB}* represents contribution to g* which is generated by the presence of short branches in the ethylene-α-olefin copolymer.

As the formula (I-II), the formula described in L. H. Tung, Journal of Polymer Science, 36, 130 (1959), pp. 287-294 is used.

A relative viscosity (ηrel) of the ethylene-α-olefin copolymer is calculated from a fall time of a sample solution measured using an Ubbelohde viscometer, the sample solution being prepared by dissolving 100 mg of the ethylene-α-olefin copolymer in 100 ml of a tetralin solution containing 5% by weight of butylhydroxytoluene (BHT) as a heat deterioration preventing agent at 135° C., and a fall time of a blank solution containing a tetralin solution containing only 0.5% by weight of BHT as the heat deterioration preventing agent.

A viscosity average molecular weight (Mv) of the ethylene-α-olefin copolymer is defined by the following formula (I-IV):

$${M}_{V} = {( \frac{{\sum }_{μ = 1}^{∞} {M}_{μ}^{a + 1} {n}_{μ}}{{\sum }_{μ = 1}^{∞} {M}_{μ} {n}_{μ}} )}^{1 / a} \qquad ( I - IV )$$

wherein a=0.725. Herein, the molecular number of a molecular weight M_{μ} is expressed by n_{μ}.

A in the formula (I-III) is estimated as:

A=((12×n+2n+1)×y)/((1000−2y−2)×14+(y+2)×15+y×13)

when the number of carbon atoms contained in a short branch is defined as n, and the number of short branches per 1000 of the number of carbon atoms obtained by NMR or infrared spectrometry is defined as y.

n is (the number of carbon atoms constituting an α-olefin)-2. For example, when 1-butene is used as the α-olefin, n=2, and when 1-hexene is used, n=4.

g*is an index expressing a shrinkage degree of a copolymer in a solution, and results from a long branch contained in the copolymer. As an amount of the long branch in the copolymer is larger, shrinkage of the copolymer becomes greater, and g* becomes smaller. g* of the ethylene-α-olefin copolymer is preferably 0.77 or lower. Such a copolymer has a short relaxation time, and is excellent in a processing property, particularly, a strain hardening property. g* of the ethylene-α-olefin copolymer is preferably 0.55 or more from the viewpoint of improvement in mechanical strength. If g* is too small, since expansion of a molecular chain when a crystal is formed is too small, a probability of production of a tie molecule is lowered, and strength is lowered. g* can be controlled by adjusting a polymerization temperature when a transition metal compound described later is used as a catalyst component which is used upon production of an ethylene-α-olefin, and g* tends to become a greater value when the polymerization temperature is raised.

A swell ratio (hereinafter, may be described as SR) of the ethylene-α-olefin copolymer of the present invention is 1.61 or more, and preferably 1.64 or more. If the swell ratio is too small, there is a tendency that it is difficult to obtain a foam having a high expansion ratio, or a foam having a great thickness. The swell ratio is preferably 2.5 or less, and more preferably 2.1 or less from the viewpoint of enhancing the smoothness of a foam surface. The swell ratio is a value (D/D₀) obtained by cooling in air a strand of an ethylene-α-olefin copolymer extruded at a length of around 15 to 20 mm from an orifice under the conditions of a temperature of 190° C. and a load of 21.18 N, upon measurement of the melt flow rate (MFR), measuring a diameter D (in mm) of the resulting strand in a solid state at a position of about 5 mm from a tip on an extrusion upstream side, and dividing the diameter D by an orifice diameter 2.095 mm (D₀). The swell ratio can be changed, for example, by adjusting a hydrogen concentration or an electron donating compound concentration, in a method for producing an ethylene-α-olefin copolymer described later.

A melt flow rate ratio (hereinafter, may be described as MFRR) of the ethylene-α-olefin copolymer of the present invention is preferably 30 or more, and more preferably 40 or more from the viewpoint of further reducing a load applied to an extruder when a copolymer is extruded. In order to obtain a foam more excellent in mechanical strength, the ratio is preferably 300 or less, more preferably 250 or less, further preferably 200 or less, and most preferably 100 or less. The MFRR is a value obtained by dividing a melt flow rate (hereinafter, may be described as H-MFR) measured under the conditions of a load of 211.82 N and a temperature of 190° C. in the method as defined in JIS K 7210-1995 by a melt flow rate (MFR) measured under the conditions of a load of 21.18N and a temperature of 190° C. in the method as defined in JIS K7210-1995. Further, the MFRR can be changed, for example, by adjusting a hydrogen concentration in a method for producing an ethylene-α-olefin copolymer described later, and when the hydrogen concentration is increased, an ethylene-α-olefin copolymer having small MFRR is obtained.

The ethylene-α-olefin copolymer of the present invention preferably has a branch of a hexyl group or a branch longer than a hexyl group from the viewpoint of increasing a melt tension to enhance foamability and the viewpoint of further reducing a load applied to an extruder when a copolymer is extruded, and the number of long branches (hereinafter, may be described as N_{LCB}) measured by NMR is preferably 0.20 or more, and preferably 0.24 or more. From the viewpoint of enhancing the mechanical strength of a foam, the N_{LCB} is preferably 1.0 or less, more preferably 0.70 or less, and most preferably 0.50 or less. An ethylene-α-olefin copolymer having an N_{LCB} in a preferable range can be obtained by selecting a transition metal compound described later as a catalyst component which is used upon production of an ethylene-α-olefin, and properly controlling the polymerization conditions such as a polymerization temperature, a polymerization pressure and a comonomer species.

The N_{LCB} is obtained by determining a proportion of an area of peaks derived from methine carbon to which a branch having a carbon atom number of 5 or more is bonded, assuming that a sum of areas of all peaks observed at 5 to 50 ppm is 1000, from ¹³C-NMR spectrum measured by a carbon nuclear magnetic resonance (¹³C-NMR) method. The peak derived from methine carbon to which a branch having a carbon atom number of 5 or more is bonded is observed at around 38.2 ppm (cf: Scientific literature Macromolecules, (USA), American Chemical Society, 1999, vol. 32, pp. 3817-3819). Since a position of this peak derived from methine carbon to which a branch having a carbon atom number of 5 or more is bonded may shift depending on a measurement apparatus and measurement conditions, it is usually determined by measuring an authentic sample for every measurement apparatus and measurement condition. It is preferable to use a negative exponential function as a window function in spectral analysis.

An activation energy of flow (hereinafter, may be described as Ea) of the ethylene-α-olefin copolymer is preferably 50 kJ/mol or more, and more preferably 55 kJ/mol or more from the viewpoint of further reducing a load applied to an extruder when a copolymer is extruded. The activation energy of flow is preferably 150 kJ/mol or less, more preferably 130 kJ/mol or less, further preferably 110 kJ/mol or less, and further more preferably 90 kJ/mol from the viewpoint of enhancing mechanical strength of a foam.

The activation energy (Ea) of flow is a value calculated according to the Arrhenius equation, with a shift factor (a_{T}) in preparing a master curve showing dependence of melt complex viscosity (in Pa □sec) on angular frequency (in rad/sec) at 190° C., according to the temperature-time superposition principle, and the value of Ea is determined by the following procedure. That is, the melt complex viscosity-angular frequency curves (unit of melt complex viscosity is Pa □sec, and unit of angular frequency is rad/sec) of the ethylene-α-olefin copolymer are obtained at temperatures (T, in ° C.) of 130° C., 150° C., 170° C. and 190° C. respectively. According to the temperature-time superposition principle, the shift factors (a_{T}) at the respective temperatures (T), obtained when the respective melt complex viscosity-angular frequency curves at the respective temperatures (T) are superposed on the melt complex viscosity-angular frequency curve of the ethylene-α-olefin copolymer at 190° C., are obtained, and then a linear approximation formula (the following formula (II)) of [ln(a_{T})] with [1/(T+273.16)] is calculated according to the least-squares method with the respective temperatures (T) and the shift factors (a_{T}) at the respective temperatures (T). Then, Ea is determined by using a value of slope m of the linear approximation formula and the following formula (III).

ln(a_{T})=m(1/(T+273.16))+n (II)

Ea=|0.008314×m| (III)

a_{T}: Shift factor

Ea: Activation energy of flow (in kJ/mol)

T: Temperature (in ° C.)

The above calculation may be carried out with using a commercially available calculation software, which includes Rhios V.4.4.4 manufactured by Rheometrics.

The shift factor (a_{T}) represents the extent of shifting, obtained when the respective melt complex viscosity-angular frequency double logarithmic curves at the respective temperatures (T) are shifted in the axis direction of log(Y)=−log(X) (wherein the y-axis represents melt complex viscosity and the x-axis represents angular frequency) to superpose on the melt complex viscosity-angular frequency double logarithmic curve at 190° C. Each of the melt complex viscosity-angular frequency double logarithmic curves at the respective temperatures (T) is superposed by shifting in amounts of a_{T} times angular frequency and 1/a_{T} times melt complex viscosity. For determining the formula (II) with the values obtained at 130° C., 150° C., 170° C. and 190° C. according to the least-squares method, a value of 0.99 or more is usually employed as a correlation coefficient.

The melt complex viscosity-angular frequency curve is measured with a viscoelasticity meter (for example, Rheometrics Mechanical Spectrometer RMS-800, manufactured by Rheometrics, etc.) usually under the conditions of a geometry of parallel plate, a plate diameter of 25 mm, a plate clearance of 1.5 to 2 mm, a strain of 5%, and an angular frequency of 0.1 to 100 rad/sec. The measurement is carried out under a nitrogen atmosphere, and a sample for measurement blended in advance with an appropriate amount (for example, 1000 ppm) of antioxidant is preferably used.

An elongational viscosity nonlinear index k expressing strength of strain hardening of the ethylene-α-olefin copolymer of the present invention is preferably greater than 0.04, more preferably greater than 0.50, further preferably greater than 0.60, and further more preferably greater than 0.70. As k is greater, a foam having a high expansion ratio is easily obtained.

The elongational viscosity nonlinear index k is a value calculated as a slope of ln α(t) at t of between 1.2 seconds to 1.7 seconds, for a curve

α(t)=σ₁(t)/σ_{0.1}(t) (5)

obtained by dividing a viscosity-time curve σ₁ (t) of a sample when the sample is monoaxially stretched at a strain rate of 1 s⁻¹ at a Hencky strain measured at 130° C. by a viscosity-time curve Go 1 (t) of a sample when the sample is monoaxially stretched at a strain rate of 0.1 s⁻¹ at Hencky strain measured at 130° C.

The measurement of the viscosity-time curve G(t) of the sample is performed using a viscoelasticity measuring apparatus (e.g. ARES, manufactured by TA Instruments etc.). In addition, the measurement is performed under a nitrogen atmosphere.

Examples of the method for producing the ethylene-α-olefin copolymer of the present invention include a method in which ethylene and α-olefin are copolymerized in the presence of a polymerization catalyst prepared by bringing the following components (A), (B) and (C) into contact with each other.

Component (A): transition metal compound represented by the following formula (1):

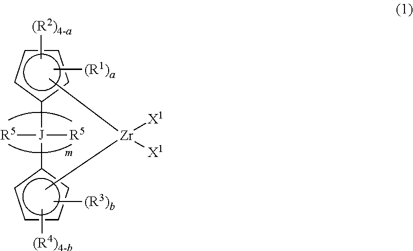

wherein R¹ and R³ represent, independently each other, an aryl group having 6 to 20 carbon atoms in which some or all of the hydrogen atoms may be substituted; R² and R⁴ represent, independently each other, a hydrogen atom, or a hydrocarbyl group having 1 to 20 carbon atoms in which some or all of the hydrogen atoms may be substituted; a and b represent, independently each other, an integer of 0 to 4, and at least one of a and b represent an integer equal to or more than 1; when there is a plural number of R¹ to R⁴ respectively, they may be the same or different respectively; X¹ represents a hydrogen atom, a halogen atom, a hydrocarbyl group having 1 to 20 carbon atoms in which some or all of the hydrogen atoms may be substituted, a hydrocarbyloxy group having 1 to 20 carbon atoms in which some or all of the hydrogen atoms may be substituted, a substituted silyl group having 1 to 20 carbon atoms, or a substituted amino group having 1 to 20 carbon atoms, and the two X¹ groups may be the same or different; m represents an integer of 1 to 5; J represents a carbon atom or a silicon atom, and when there is a plural number of J, they may be the same or different; R⁵ represents a hydrogen atom, or a hydrocarbyl group having 1 to 20 carbon atoms in which some or all of the hydrogen atoms may be substituted, and the R⁵ groups may be the same or different.

Component B: solid catalytic component prepared by bringing the following components (a), (b) and (c) into contact with each other.

Component (a): compound represented by the following formula (2)

ZnL₂ (2)

Component (b): compound represented by the following formula (3)

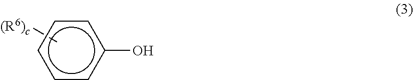

Component (c): H₂O

Component (d): SiO₂

In the above formulas, L represents a hydrocarbyl group having 1 to 20 carbon atoms in which some or all of the hydrogen atoms may be substituted; the two L groups may be the same or different; R⁶ represents an electron withdrawing group or a group containing an electron withdrawing group; c represents an integer of 1 to 5; when there is a plural number of R⁶, they may be the same or different.

Component (C): organoaluminum compound

R¹ and R³ in the formula (1) represent, independently each other, an aryl group having 6 to 20 carbon atoms in which some or all of the hydrogen atoms may be substituted; when there is a plural number of R¹, they may be the same or different; when there is a plural number of R³, they may be the same or different.

Examples of an aryl group having 6 to 20 carbon atoms in which some or all of the hydrogen atoms may be substituted of R¹ and R³ include an aryl group having 6 to 20 carbon atoms, an aryl group having 6 to 20 carbon atoms in which some or all of the hydrogen atoms are substituted by a halogen atom, an aryl group having 6 to 20 carbon atoms in which some or all of the hydrogen atoms are substituted by a substituted silyl group having 1 to 20 carbon atoms, an aryl group having 6 to 20 carbon atoms in which some or all of the hydrogen atoms are substituted by a substituted amino group having 1 to 20 carbon atoms, an aryl group having 6 to 20 carbon atoms in which some or all of the hydrogen atoms are substituted by a hydrocarbyloxy group having 1 to 20 carbon atoms, and the like.

Examples of the aryl group having 6 to 20 carbon atoms include a phenyl group, a 2-tolyl group, a 3-tolyl group, a 4-tolyl group, a 2,3-xylyl group, a 2,4-xylyl group, a 2,5-xylyl group, a 2,6-xylyl group, a 3,4-xylyl group, a 3,5-xylyl group, a 2,3,4-trimethylphenyl group, a 2,3,5-trimethylphenyl group, a 2,3,6-trimethylphenyl group, a 2,4,6-trimethylphenyl group, a 3,4,5-trimethylphenyl group, a 2,3,4,5-tetramethylphenyl group, a 2,3,4,6-tetramethylphenyl group, a 2,3,5,6-tetramethylphenyl group, a pentamethylphenyl group, an ethylphenyl group, a diethylphenyl group, a triethylphenyl group, an n-propylphenyl group, an isopropylphenyl group, an n-butylphenyl group, a sec-butylphenyl group, a tert-butylphenyl group, an n-pentylphenyl group, a neopentylphenyl group, an n-hexylphenyl group, an n-octylphenyl group, an n-decylphenyl group, an n-dodecylphenyl group, an n-tetradecylphenyl group, a naphthyl group, an anthracenyl group and the like.

Examples of the aryl group having 6 to 20 carbon atoms in which some or all of the hydrogen atoms are substituted by a halogen atom include a 2-fluorophenyl group, a 3-fluorophenyl group, a 4-fluorophenyl group, a 2-chlorophenyl group, a 3-chlorophenyl group, a 4-chlorophenyl group, a 2-bromophenyl group, a 3-bromophenyl group, a 4-bromophenyl group, a 2-iodophenyl group, a 3-iodophenyl group, a 4-iodophenyl group and the like.

Examples of the aryl group having 6 to 20 carbon atoms in which some or all of the hydrogen atoms are substituted by a substituted silyl group having 1 to 20 carbon atoms include a trimethylsilylphenyl group, a bis(trimethylsilyl)phenyl group and the like.

Examples of the aryl group having 6 to 20 carbon atoms in which some or all of the hydrogen atoms are substituted by a substituted amino group having 1 to 20 carbon atoms include a dimethylaminophenyl group, a bis(dimethylamino)phenyl group, a diphenylaminophenyl group and the like.

Examples of the aryl group having 6 to 20 carbon atoms in which some or all of the hydrogen atoms are substituted by a hydrocarbyloxy group having 1 to 20 carbon atoms include a methoxyphenyl group, an ethoxyphenyl group, an n-propoxyphenyl group, an isopropoxyphenyl group, an n-butoxyphenyl group, a sec-butoxyphenyl group, a tert-butoxyphenyl group, a phenoxyphenyl group and the like.

R¹ and R³ are preferably the aryl group having 6 to 20 carbon atoms, and more preferably a phenyl group.

R² and R⁴ in the formula (1) represent, independently each other, a hydrogen atom, or a hydrocarbyl group having 1 to 20 carbon atoms in which some or all of the hydrogen atoms may be substituted. When there is a plural number of R², they may be the same or different, and when there is a plural number of R⁴, they may be the same or different.

Examples of the hydrocarbyl group having 1 to 20 carbon atoms in which some or all of the hydrogen atoms may be substituted of R² and R⁴ include an alkyl group having 1 to 20 carbon atoms in which some or all of the hydrogen atoms may be substituted, an aralkyl group having 7 to 20 carbon atoms in which some or all of the hydrogen atoms may be substituted, an aryl group having 6 to 20 carbon atoms in which some or all of the hydrogen atoms may be substituted, and the like.

Examples of the alkyl group having 1 to 20 carbon atoms in which some or all of the hydrogen atoms may be substituted include an alkyl group having 1 to 20 carbon atoms, an alkyl group having 1 to 20 carbon atoms in which some or all of the hydrogen atoms are substituted by a halogen atom, an alkyl group having 1 to 20 carbon atoms in which some or all of the hydrogen atoms are substituted by a substituted silyl group having 1 to 20 carbon atoms, an alkyl group having 1 to 20 carbon atoms in which some or all of the hydrogen atoms are substituted by a substituted amino group having 1 to 20 carbon atoms, an alkyl group having 1 to 20 carbon atoms in which some or all of the hydrogen atoms are substituted by a hydrocarbyloxy group having 1 to 20 carbon atoms, and the like.

Examples of the alkyl group having 1 to 20 carbon atoms include a methyl group, an ethyl group, an n-propyl group, an isopropyl group, an n-butyl group, a sec-butyl group, a tert-butyl group, an n-pentyl group, a neopentyl group, an isopentyl group, an n-hexyl group, an n-heptyl group, an n-octyl group, an n-decyl group, an n-nonyl group, an n-undecyl group, an n-dodecyl group, an n-tridecyl group, an n-tetradecyl group, an n-pentadecyl group, an n-hexadecyl group, an n-heptadecyl group, an n-octadecyl group, an n-nonadecyl group, an n-eicosyl group and the like.

Examples of the alkyl group having 1 to 20 carbon atoms in which some or all of the hydrogen atoms are substituted by a halogen atom include a fluoromethyl group, a difluoromethyl group, a trifluoromethyl group, a chloromethyl group, a dichloromethyl group, a trichloromethyl group, a bromomethyl group, a dibromomethyl group, a tribromomethyl group, an iodomethyl group, a diiodomethyl group, a triiodomethyl group, a fluoroethyl group, a difluoroethyl group, a trifluoroethyl group, a tetrafluoroethyl group, a pentafluoroethyl group, a chloroethyl group, a dichloroethyl group, a trichloroethyl group, a tetrachloroethyl group, a pentachloroethyl group, a bromoethyl group, a dibromoethyl group, a tribromoethyl group, a tetrabromoethyl group, a pentabromoethyl group, a perfluoropropyl group, a perfluorobutyl group, a perfluoropentyl group, a perfluorohexyl group, a perfluorooctyl group, a perfluorododecyl group, a perfluoropentadecyl group, a perfluoroeicosyl group, a perchloropropyl group, a perchlorobutyl group, a perchloropentyl group, a perchlorohexyl group, a perchlorooctyl group, a perchlorododecyl group, a perchloropentadecyl group, a perchloroeicosyl group, a perbromopropyl group, a perbromobutyl group, a perbromopentyl group, a perbromohexyl group, a perbromooctyl group, a perbromododecyl group, a perbromopentadecyl group, a perbromoeicosyl group and the like.

Examples of the alkyl group having 1 to 20 carbon atoms in which some or all of the hydrogen atoms are substituted by a substituted silyl group having 1 to 20 carbon atoms include a trimethylsilylmethyl group, a trimethylsilylethyl group, a trimethylsilylpropyl group, a trimethylsilylbutyl group, a bis(trimethylsilyl)methyl group, a bis(trimethylsilyl)ethyl group, a bis(trimethylsilyl)propyl group, a bis(trimethylsilyl)butyl group, a triphenylsilylmethyl group and the like.

Examples of the alkyl group having 1 to 20 carbon atoms in which some or all of the hydrogen atoms are substituted by a substituted amino group having 1 to 20 carbon atoms include a dimethylaminomethyl group, a dimethylaminoethyl group, a dimethylaminopropyl group, a dimethylaminobutyl group, a bis(dimethylamino)methyl group, a bis(dimethylamino)ethyl group, a bis(dimethylamino)propyl group, a bis(dimethylamino)butyl group, a phenylaminomethyl group, a diphenylaminomethyl group and the like.

Examples of the alkyl group having 1 to 20 carbon atoms in which some or all of the hydrogen atoms are substituted by a hydrocarbyloxy group having 1 to 20 carbon atoms include a methoxymethyl group, an ethoxymethyl group, an n-propoxymethyl group, an isopropoxymethyl group, an n-butoxymethyl group, a sec-butoxymethyl group, a tert-butoxymethyl group, a phenoxymethyl group, a methoxyethyl group, an ethoxyethyl group, an n-propoxyethyl group, an isopropoxyethyl group, an n-butoxyethyl group, a sec-butoxyethyl group, a tert-butoxyethyl group, a phenoxyethyl group, a methoxy-n-propyl group, an ethoxy-n-propyl group, an n-propoxy-n-propyl group, an isopropoxy-n-propyl group, an n-butoxy-n-propyl group, a sec-butoxy-n-propyl group, a tert-butoxy-n-propyl group, a phenoxy-n-propyl group, a methoxyisopropyl group, an ethoxyisopropyl group, an n-propoxyisopropyl group, an isopropoxyisopropyl group, an n-butoxyisopropyl group, a sec-butoxyisopropyl group, a tert-butoxyisopropyl group, a phenoxyisopropyl group and the like.

Examples of the aralkyl group having 7 to 20 carbon atoms in which some or all of the hydrogen atoms may be substituted include an aralkyl group having 7 to 20 carbon atoms, an aralkyl group having 7 to 20 carbon atoms in which some or all of the hydrogen atoms are substituted by a halogen atom, and the like.

Examples of the aralkyl group having 7 to 20 carbon atoms include a benzyl group, a (2-methylphenyl)methyl group, a (3-methylphenyl)methyl group, a (4-methylphenyl)methyl group, a (2,3-dimethylphenyl)methyl group, a (2,4-dimethylphenyl)methyl group, a (2,5-dimethylphenyl)methyl group, a (2,6-dimethylphenyl)methyl group, a (3,4-dimethylphenyl)methyl group, a (4,6-dimethylphenyl)methyl group, a (2,3,4-trimethylphenyl)methyl group, a (2,3,5-trimethylphenyl)methyl group, a (2,3,6-trimethylphenyl)methyl group, a (3,4,5-trimethylphenyl)methyl group, a (2,4,6-trimethylphenyl)methyl group, a (2,3,4,5-tetramethylphenyl)methyl group, a (2,3,4,6-tetramethylphenyl)methyl group, a (2,3,5,6-tetramethylphenyl)methyl group, a (pentamethylphenyl)methyl group, an (ethylphenyl)methyl group, an (n-propylphenyl)methyl group, an (isopropylphenyl)methyl group, an (n-butylphenyl)methyl group, a (sec-butylphenyl)methyl group, a (tert-butylphenyl)methyl group, an (n-pentylphenyl)methyl group, a (neopentylphenyl)methyl group, an (n-hexylphenyl)methyl group, an (n-octylphenyl)methyl group, an (n-decylphenyl)methyl group, an (n-dodecylphenyl)methyl group, an (n-tetradecylphenyl)methyl group, a naphthylmethyl group, an anthracenylmethyl group, a phenylethyl group, a phenylpropyl group, a phenylbutyl group, a diphenylmethyl group, a diphenylethyl group, a diphenylpropyl group, a diphenylbutyl group and the like.

Examples of the aralkyl group having 7 to 20 carbon atoms in which some or all of the hydrogen atoms are substituted by a halogen atom include a 2-fluorobenzyl group, a 3-fluorobenzyl group, a 4-fluorobenzyl group, a 2-chlorobenzyl group, a 3-chlorobenzyl group, a 4-chlorobenzyl group, a 2-bromobenzyl group, a 3-bromobenzyl group, a 4-bromobenzyl group, a 2-iodobenzyl group, a 3-iodobenzyl group, a 4-iodobenzyl group and the like.

Examples of the aryl group having 6 to 20 carbon atoms which may be substituted include the aryl groups exemplified as the aryl group having 6 to 20 carbon atoms in which some or all of the hydrogen atoms may be substituted of R¹ and R³.

R² and R⁴ are preferably a hydrogen atom or an alkyl group having 1 to 6 carbon atoms, more preferably a hydrogen atom or an alkyl group having 1 to 4 carbon atoms, and further preferably a hydrogen atom.

a and b in the formula (1) represent, independently each other, an integer of 0 to 4, and at least one of a and b represent an integer equal to or more than 1.

X¹ in the formula (1) represents a hydrogen atom, a halogen atom, a hydrocarbyl group having 1 to 20 carbon atoms in which some or all of the hydrogen atoms may be substituted, a hydrocarbyloxy group having 1 to 20 carbon atoms in which some or all of the hydrogen atoms may be substituted, a substituted silyl group having 1 to 20 carbon atoms, or a substituted amino group having 1 to 20 carbon atoms. The two X¹ groups may be the same or different.

Examples of the halogen atom of X¹ include a fluorine atom, a chlorine atom, a bromine atom, an iodine atom and the like.

Examples of the hydrocarbyl group having 1 to 20 carbon atoms in which some or all of the hydrogen atoms may be substituted of X¹ include the hydrocarbyl groups described as the hydrocarbyl group having 1 to 20 carbon atoms in which some or all of the hydrogen atoms may be substituted of R² and R⁴.

Examples of the hydrocarbyloxy group having 1 to 20 carbon atoms in which some or all of the hydrogen atoms may be substituted of X¹ include an alkoxy group having 1 to 20 carbon atoms in which some or all of the hydrogen atoms may be substituted, an aralkyloxy group having 7 to 20 carbon atoms in which some or all of the hydrogen atoms may be substituted, an aryloxy group having 6 to 20 carbon atoms in which some or all of the hydrogen atoms may be substituted, and the like.

Examples of the alkoxy group having 1 to 20 carbon atoms in which some or all of the hydrogen atoms may be substituted include an alkoxy group having 1 to 20 carbon atoms, an alkoxy group having 1 to 20 carbon atoms in which some or all of the hydrogen atoms are substituted by a halogen atom, and the like.

Examples of the alkoxy group having 1 to 20 carbon atoms include a methoxy group, an ethoxy group, an n-propoxy group, an isopropoxy group, an n-butoxy group, a sec-butoxy group, a tert-butoxy group, an n-pentyloxy group, a neopentyloxy group, an n-hexyloxy group, an n-octyloxy group, an n-nonyloxy group, an n-decyloxy group, an n-undecyloxy group, n-dodecyloxy group, an n-tridecyloxy group, an n-tetradecyloxy group, an n-pentadecyloxy group, an n-hexadecyloxy group, an n-heptadecyloxy group, an n-octadecyloxy group, an n-nonadecyloxy group, an n-eicosoxy group and the like.

Examples of the alkoxy group having 1 to 20 carbon atoms in which some or all of the hydrogen atoms are substituted by a halogen atom include a fluoromethyloxy group, a difluoromethyloxy group, a trifluoromethyloxy group, a chloromethyloxy group, a dichloromethyloxy group, a trichloromethyloxy group, a bromomethyloxy group, a dibromomethyloxy group, a tribromomethyloxy group, an iodomethyloxy group, a diiodomethyloxy group, a triiodomethyloxy group, a fluoroethyloxy group, a difluoroethyloxy group, a trifluoroethyloxy group, a tetrafluoroethyloxy group, a pentafluoroethyloxy group, a chloroethyloxy group, a dichloroethyloxy group, a trichloroethyloxy group, a tetrachloroethyloxy group, a pentachloroethyloxy group, a bromoethyloxy group, a dibromoethyloxy group, a tribromoethyloxy group, a tetrabromoethyloxy group, a pentabromoethyloxy group, a perfluoropropyloxy group, a perfluorobutyloxy group, a perfluoropentyloxy group, a perfluorohexyloxy group, a perfluorooctyloxy group, a perfluorododecyloxy group, a perfluoropentadecyloxy group, a perfluoroeicosyloxy group, a perchloropropyloxy group, a perchlorobutyloxy group, a perchloropentyloxy group, a perchlorohexyloxy group, a perchlorooctyloxy group, a perchlorododecyloxy group, a perchloropentadecyloxy group, a perchloroeicosyloxy group, a perbromopropyloxy group, a perbromobutyloxy group, a perbromopentyloxy group, a perbromohexyloxy group, a perbromooctyloxy group, a perbromododecyloxy group, a perbromopentadecyloxy group, a perbromoeicosyloxy group and the like.

Examples of the aralkyloxy group having 7 to 20 carbon atoms in which some or all of the hydrogen atoms may be substituted include an aralkyloxy group having 7 to 20 carbon atoms, an aralkyloxy group having 7 to 20 carbon atoms in which some or all of the hydrogen atoms are substituted by a halogen atom, and the like.

Examples of the aralkyloxy group having 7 to 20 carbon atoms include a benzyloxy group, a (2-methylphenyl)methoxy group, a (3-methylphenyl)methoxy group, a (4-methylphenyl)methoxy group, a (2,3-dimethylphenyl)methoxy group, a (2,4-dimethylphenyl)methoxy group, a (2,5-dimethylphenyl)methoxy group, a (2,6-dimethylphenyl)methoxy group, a (3,4-dimethylphenyl)methoxy group, a (3,5-dimethylphenyl)methoxy group, a (2,3,4-trimethylphenyl)methoxy group, a (2,3,5-trimethylphenyl)methoxy group, a (2,3,6-trimethylphenyl)methoxy group, a (2,4,5-trimethylphenyl)methoxy group, a (2,4,6-trimethylphenyl)methoxy group, a (3,4,5-trimethylphenyl)methoxy group, a (2,3,4,5-tetramethylphenyl)methoxy group, a (2,3,4,6-tetramethylphenyl)methoxy group, a (2,3,5,6-tetramethylphenyl)methoxy group, a (pentamethylphenyl)methoxy group, an (ethylphenyl)methoxy group, an (n-propylphenyl)methoxy group, an (isopropylphenyl)methoxy group, an (n-butylphenyl)methoxy group, a (sec-butylphenyl)methoxy group, a (tert-butylphenyl)methoxy group, an (n-hexylphenyl)methoxy group, an (n-octylphenyl)methoxy group, an (n-decylphenyl)methoxy group, an (n-tetradecylphenyl)methoxy group, a naphthylmethoxy group, an anthracenylmethoxy group and the like.

Examples of the aralkyloxy group having 7 to 20 carbon atoms in which some or all of the hydrogen atoms are substituted by a halogen atom include a 2-fluorobenzyloxy group, a 3-fluorobenzyloxy group, a 4-fluorobenzyloxy group, a 2-chlorobenzyloxy group, a 3-chlorobenzyloxy group, a 4-chlorobenzyloxy group, a 2-bromobenzyloxy group, a 3-bromobenzyloxy group, a 4-bromobenzyloxy group, a 2-iodobenzyloxy group, a 3-iodobenzyloxy group, a 4-iodobenzyloxy group and the like.

Examples of the aryloxy group having 6 to 20 carbon atoms in which some or all of the hydrogen atoms may be substituted include an aryloxy group having 6 to 20 carbon atoms, an aryloxy group having 6 to 20 carbon atoms which are substituted by a halogen atom, and the like.

Examples of the aryloxy group having 6 to 20 carbon atoms include a phenoxy group, a 2-methylphenoxy group, a 3-methylphenoxy group, a 4-methylphenoxy group, a 2,3-dimethylphenoxy group, a 2,4-dimethylphenoxy group, a 2,5-dimethylphenoxy group, a 2,6-dimethylphenoxy group, a 3,4-dimethylphenoxy group, a 3,5-dimethylphenoxy group, a 2,3,4-trimethylphenoxy group, a 2,3,5-trimethylphenoxy group, a 2,3,6-trimethylphenoxy group, a 2,4,5-trimethylphenoxy group, a 2,4,6-trimethylphenoxy group, a 3,4,5-trimethylphenoxy group, a 2,3,4,5-tetramethylphenoxy group, a 2,3,4,6-tetramethylphenoxy group, a 2,3,5,6-tetramethylphenoxy group, a pentamethylphenoxy group, an ethylphenoxy group, an n-propylphenoxy group, an isopropylphenoxy group, an n-butylphenoxy group, a sec-butylphenoxy group, a tert-butylphenoxy group, an n-hexylphenoxy group, an n-octylphenoxy group, an n-decylphenoxy group, an n-tetradecylphenoxy group, a naphthoxy group, an anthrathenoxy group and the like.

Examples of the aryloxy group having 6 to 20 carbon atoms in which some or all of the hydrogen atoms are substituted by a halogen atom include a 2-fluorophenyloxy group, a 3-fluorophenyloxy group, a 4-fluorophenyloxy group, a 2-chlorophenyloxy group, a 3-chlorophenyloxy group, a 4-chlorophenyloxy group, a 2-bromophenyloxy group, a 3-bromophenyloxy group, a 4-bromophenyloxy group, a 2-iodophenyloxy group, a 3-iodophenyloxy group, a 4-iodophenyloxy group and the like.

Examples of the substituted silyl group having 1 to 20 carbon atoms of X¹ include a monosubstituted silyl group substituted by a hydrocarbyl group having 1 to 20 carbon atoms, a disubstituted silyl group substituted by a hydrocarbyl group having 1 to 20 carbon atoms, a trisubstituted silyl group substituted by a hydrocarbyl group having 1 to 20 carbon atoms, and the like. Examples of the hydrocarbyl group having 1 to 20 carbon atoms include an alkyl group having 1 to 20 carbon atoms, an aryl group having 6 to 20 carbon atoms, and the like. Examples of the monosubstituted silyl group substituted by a hydrocarbyl group having 1 to 20 carbon atoms include a methylsilyl group, an ethylsilyl group, an n-propylsilyl group, an isopropylsilyl group, an n-butylsilyl group, a sec-butylsilyl group, a tert-butylsilyl group, an isobutylsilyl group, an n-pentylsilyl group, an n-hexylsilyl group, a phenylsilyl group and the like. Examples of the disubstituted silyl group substituted by a hydrocarbyl group having 1 to 20 carbon atoms include a dimethylsilyl group, a diethylsilyl group, a di-n-propylsilyl group, a diisopropylsilyl group, a di-n-butylsilyl group, a di-sec-butylsilyl group, a di-tert-butylsilyl group, a diisobutylsilyl group, a diphenylsilyl group and the like. Examples of the trisubstituted silyl group substituted by a hydrocarbyl group having 1 to 20 carbon atoms include a trimethylsilyl group, a triethylsilyl group, a tri-n-propylsilyl group, a triisopropylsilyl group, a tri-n-butylsilyl group, a tri-sec-butylsilyl group, a tri-tert-butylsilyl group, a triisobutylsilyl group, a tert-butyl-dimethylsilyl group, a tri-n-pentylsilyl group, a tri-n-hexylsilyl group, a tricyclohexylsilyl group, a triphenylsilyl group and the like.

Examples of the substituted amino group having 1 to 20 carbon atoms of X¹ include an amino group substituted by a hydrocarbyl group having 1 to 20 carbon atoms, and the like. Examples of the hydrocarbyl group having 1 to 20 carbon atoms include an alkyl group having 1 to 20 carbon atoms, an aryl group having 6 to 20 carbon atoms, and the like. Examples of the amino group substituted by a hydrocarbyl group having 1 to 20 carbon atoms include a phenylamino group, a benzylamino group, a dimethylamino group, a diethylamino group, a di-n-propylamino group, a diisopropylamino group, a di-n-butylamino group, a di-sec-butylamino group, a di-tert-butylamino group, a diisobutylamino group, a di-n-hexylamino group, a di-n-octylamino group, a di-n-decylamino group, a diphenylamino group, a dibenzylamino group, a tert-butylisopropylamino group, a phenylethylamino group, a phenylpropylamino group, a phenylbutylamino group, a pyrrolyl group, a pyrrolidinyl group, a piperidinyl group, a carbazolyl group, a dihydroisoindolyl group and the like.

X¹ is preferably a chlorine atom, a methyl group, an ethyl group, an n-propyl group, an isopropyl group, an n-butyl group, a methoxy group, an ethoxy group, an n-propoxy group, an isopropoxy group, an n-butoxy group, a trifluoromethoxy group, a phenyl group, a phenoxy group, a 2,6-di-tert-butylphenoxy group, a 3,4,5-trifluorophenoxy group, a pentafluorophenoxy group, a 2,3,5,6-tetrafluoro-4-pentafluorophenylphenoxy group or a benzyl group.

m in the formula (1) represents an integer of 1 to 5. m is preferably 1 or 2.

J in the formula (1) represents a carbon atom or a silicon atom. When there is a plural number of J, they may be the same or different.

R⁵ in the formula (1) represents, independently each other, a hydrogen atom, or a hydrocarbyl group having 1 to 20 carbon atoms which may be substituted. The R⁵ groups may be the same or different.

Examples of the hydrocarbyl group having 1 to 20 carbon atoms in which some or all of the hydrogen atoms may be substituted of R⁵ include the hydrocarbyl groups described as the hydrocarbyl group having 1 to 20 carbon atoms in which some or all of the hydrogen atoms may be substituted of R² and R⁴.

Examples of the cross-linking group represented by the following formula (4) in the formula (1):

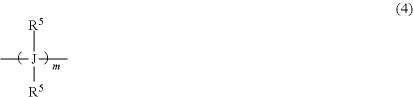

include a methylene group, an ethylidene group, an ethylene group, a propylidene group, a propylene group, a butylidene group, a butylene group, a pentylidene group, a pentylene group, a hexylidene group, an isopropylidene group, a methylethylmethylene group, a methylpropylmethylene group, a methylbutylmethylene group, a bis(cyclohexyl)methylene group, a methylphenylmethylene group, a diphenylmethylene group, a phenyl(methylphenyl)methylene group, a di(methylphenyl)methylene group, a bis(dimethylphenyl)methylene group, a bis(trimethylphenyl)methylene group, a phenyl(ethylphenyl)methylene group, a di(ethylphenyl)methylene group, a bis(diethylphenyl)methylene group, a phenyl(propylphenyl)methylene group, a di(propylphenyl)methylene group, a bis(dipropylphenyl)methylene group, a phenyl(butylphenyl)methylene group, a di(butylphenyl)methylene group, a phenyl(naphthyl)methylene group, a di(naphthyl)methylene group, a phenyl(biphenyl)methylene group, a di(biphenyl)methylene group, a phenyl(trimethylsilylphenyl)methylene group, a bis(trimethylsilylphenyl)methylene group, a bis(pentafluorophenyl)methylene group, a silanediyl group, a disilanediyl group, a trisilanediyl group, a tetrasilanediyl group, a dimethylsilanediyl group, a bis(dimethylsilane)diyl group, a diethylsilanediyl group, a dipropylsilanediyl group, a dibutylsilanediyl group, a diphenylsilanediyl group, a silacyclobutanediyl group, a silacyclohexanediyl group, a divinylsilanediyl group, a diallylsilanediyl group, a (methyl)(vinyl)silanediyl group, an (allyl)(methyl)silanediyl group and the like.

The cross-linking group represented by the formula (4) is preferably a methylene group, an ethylene group, an isopropylidene group, a bis(cyclohexyl)methylene group, a diphenylmethylene group, a dimethylsilanediyl group, a bis(dimethylsilane)diyl group or a diphenylsilanediyl group, and more preferably an isopropylidene group or a dimethylsilanediyl group.

Examples of the transition metal compound represented by the formula (1) of the component (A) include dimethylsilylenebis(2-phenylcyclopentadienyl)zirconiumdichloride, dimethylsilylenebis(3-phenylcyclopentadienyl)zirconiumdichloride, dimethylsilylenebis(2,3-diphenylcyclopentadienyl)zirconiumdichloride, dimethylsilylenebis(2,4-diphenylcyclopentadienyl)zirconiumdichloride, dimethylsilylenebis(2,5-diphenylcyclopentadienyl)zirconiumdichloride, dimethylsilylenebis(3,4-diphenylcyclopentadienyl)zirconiumdichloride, dimethylsilylenebis(2,3,4-triphenylcyclopentadienyl)zirconiumdichloride, dimethylsilylenebis(2,3,5-triphenylcyclopentadienyl) zirconiumdichloride, and dimethylsilylenebis(tetraphenylcyclopentadienyl)zirconiumdichloride, and also include compounds in which dimethylsilylene in the above-mentioned compounds is replaced by methylene, ethylene, isopropylidene, bis(cyclohexyl)methylene, diphenylmethylene, dimethylsilanediyl, bis(dimethylsilane)diyl or diphenylsilanediyl, compounds in which dichloride in the above-mentioned compounds is replaced by difluoride, dibromide, diiodide, dimethyl, diethyl, diisopropyl, diphenyl, dibenzyl, dimethoxide, diethoxide, di(n-propoxide), di(isopropoxide), diphenoxide or di(pentafluorophenoxide), and the like.

The transition metal compound represented by the formula (1) of the component (A) is preferably dimethylsilylenebis(3-phenylcyclopentadienyl)dichloride.

L in the formula (2) represents a hydrocarbyl group having 1 to 20 carbon atoms in which some or all of the hydrogen atoms may be substituted. The two L groups may be the same or different.

Examples of the hydrocarbyl group having 1 to 20 carbon atoms in which some or all of the hydrogen atoms may be substituted of L include an alkyl group having 1 to 20 carbon atoms in which some or all of the hydrogen atoms may be substituted, an aralkyl group having 7 to 20 carbon atoms in which some or all of the hydrogen atoms may be substituted, an aryl group having 6 to 20 carbon atoms in which some or all of the hydrogen atoms may be substituted, and the like.

Examples of the alkyl group having 1 to 20 carbon atoms in which some or all of the hydrogen atoms may be substituted include an alkyl group having 1 to 20 carbon atoms, an alkyl group having 1 to 20 carbon atoms in which some or all of the hydrogen atoms are substituted by a halogen atom, and the like.

Examples of the alkyl group having 1 to 20 carbon atoms include a methyl group, an ethyl group, an n-propyl group, an isopropyl group, an n-butyl group, a sec-butyl group, a tert-butyl group, an n-pentyl group, a neopentyl group, an isopentyl group, an n-hexyl group, an n-heptyl group, an n-octyl group, an n-nonyl group, an n-decyl group, an n-undecyl group, an n-dodecyl group, an n-tridecyl group, an n-tetradecyl group, an n-pentadecyl group, an n-hexadecyl group, an n-heptadecyl group, an n-octadecyl group, an n-nonadecyl group, an n-eicosyl group and the like. The alkyl group having 1 to 20 carbon atoms is preferably a methyl group, an ethyl group, an isopropyl group, a tert-butyl group or an isobutyl group.

Examples of the alkyl group having 1 to 20 carbon atoms in which some or all of the hydrogen atoms are substituted by a halogen atom include a fluoromethyl group, a difluoromethyl group, a trifluoromethyl group, a chloromethyl group, a dichloromethyl group, a trichloromethyl group, a bromomethyl group, a dibromomethyl group, a tribromomethyl group, an iodomethyl group, a diiodomethyl group, a triiodomethyl group, a fluoroethyl group, a difluoroethyl group, a trifluoroethyl group, a tetrafluoroethyl group, a pentafluoroethyl group, a chloroethyl group, a dichloroethyl group, a trichloroethyl group, a tetrachloroethyl group, a pentachloroethyl group, a bromoethyl group, a dibromoethyl group, a tribromoethyl group, a tetrabromoethyl group, a pentabromoethyl group, a perfluoropropyl group, a perfluorobutyl group, a perfluoropentyl group, a perfluorohexyl group, a perfluorooctyl group, a perfluorododecyl group, a perfluoropentadecyl group, a perfluoroeicosyl group, a perchloropropyl group, a perchlorobutyl group, a perchloropentyl group, a perchlorohexyl group, a perchlorooctyl group, a perchlorododecyl group, a perchloropentadecyl group, a perchloroeicosyl group, a perbromopropyl group, a perbromobutyl group, a perbromopentyl group, a perbromohexyl group, a perbromooctyl group, a perbromododecyl group, a perbromopentadecyl group, a perbromoeicosyl group and the like.

Examples of the aralkyl group having 7 to 20 carbon atoms in which some or all of the hydrogen atoms may be substituted include an aralkyl group having 7 to 20 carbon atoms, an aralkyl group having 7 to 20 carbon atoms in which some or all of the hydrogen atoms are substituted by a halogen atom, and the like.

Examples of the aralkyl group having 7 to 20 carbon atoms include a benzyl group, a (2-methylphenyl)methyl group, a (3-methylphenyl)methyl group, a (4-methylphenyl)methyl group, a (2,3-dimethylphenyl)methyl group, a (2,4-dimethylphenyl)methyl group, a (2,5-dimethylphenyl)methyl group, a (2,6-dimethylphenyl)methyl group, a (3,4-dimethylphenyl)methyl group, a (4,6-dimethylphenyl)methyl group, a (2,3,4-trimethylphenyl)methyl group, a (2,3,5-trimethylphenyl)methyl group, a (2,3,6-trimethylphenyl)methyl group, a (3,4,5-trimethylphenyl)methyl group, a (2,4,6-trimethylphenyl)methyl group, a (2,3,4,5-tetramethylphenyl)methyl group, a (2,3,4,6-tetramethylphenyl)methyl group, a (2,3,5,6-tetramethylphenyl)methyl group, a (pentamethylphenyl)methyl group, an (ethylphenyl)methyl group, an (n-propylphenyl)methyl group, an (isopropylphenyl)methyl group, an (n-butylphenyl)methyl group, a (sec-butylphenyl)methyl group, a (tert-butylphenyl)methyl group, an (n-pentylphenyl)methyl group, a (neopentylphenyl)methyl group, an (n-hexylphenyl)methyl group, an (n-octylphenyl)methyl group, an (n-decylphenyl)methyl group, an (n-decylphenyl)methyl group, an (n-tetradecylphenyl)methyl group, a naphthylmethyl group, an anthracenylmethyl group, a phenylethyl group, a phenylpropyl group, a phenylbutyl group, a diphenylmethyl group, a diphenylethyl group, a diphenylpropyl group, a diphenylbutyl group and the like. The aralkyl group having 7 to 20 carbon atoms is preferably a benzyl group.

Examples of the aralkyl group having 7 to 20 carbon atoms in which some or all of the hydrogen atoms are substituted by a halogen atom include a 2-fluorobenzyl group, a 3-fluorobenzyl group, a 4-fluorobenzyl group, a 2-chlorobenzyl group, a 3-chlorobenzyl group, a 4-chlorobenzyl group, a 2-bromobenzyl group, a 3-bromobenzyl group, a 4-bromobenzyl group, a 2-iodobenzyl group, a 3-iodobenzyl group, a 4-iodobenzyl group and the like.

Examples of the aryl group having 6 to 20 carbon atoms in which some or all of the hydrogen atoms may be substituted include an aryl group having 6 to 20 carbon atoms, an aryl group having 6 to 20 carbon atoms which are substituted by a halogen atom, and the like.

Examples of the aryl group having 6 to 20 carbon atoms include a phenyl group, a 2-tolyl group, a 3-tolyl group, a 4-tolyl group, a 2,3-xylyl group, a 2,4-xylyl group, a 2,5-xylyl group, a 2,6-xylyl group, a 3,4-xylyl group, a 3,5-xylyl group, a 2,3,4-trimethylphenyl group, a 2,3,5-trimethylphenyl group, a 2,3,6-trimethylphenyl group, a 2,4,6-trimethylphenyl group, a 3,4,5-trimethylphenyl group, a 2,3,4,5-tetramethylphenyl group, a 2,3,4,6-tetramethylphenyl group, a 2,3,5,6-tetramethylphenyl group, a pentamethylphenyl group, an ethylphenyl group, a diethylphenyl group, a triethylphenyl group, an n-propylphenyl group, an isopropylphenyl group, an n-butylphenyl group, a sec-butylphenyl group, a tert-butylphenyl group, an n-pentylphenyl group, a neopentylphenyl group, an n-hexylphenyl group, an n-octylphenyl group, an n-decylphenyl group, an n-dodecylphenyl group, an n-tetradecylphenyl group, a naphthyl group, an anthracenyl group and the like. The aryl group having 6 to 20 carbon atoms is preferably a phenyl group.

Examples of the aryl group having 6 to 20 carbon atoms in which some or all of the hydrogen atoms are substituted by a halogen atom include a 2-fluorophenyl group, a 3-fluorophenyl group, a 4-fluorophenyl group, a 2-chlorophenyl group, a 3-chlorophenyl group, a 4-chlorophenyl group, a 2-bromophenyl group, a 3-bromophenyl group, a 4-bromophenyl group, a 2-iodophenyl group, a 3-iodophenyl group, a 4-iodophenyl group and the like.

L is preferably the alkyl group having 1 to 20 carbon atoms or the aryl group having 6 to 20 carbon atoms, and more preferably the alkyl group having 1 to 20 carbon atoms.

Examples of the compound represented by the formula (2) of the component (a) include a dialkyl zinc, a diaryl zinc, a dialkenyl zinc, bis(cyclopentadienyl) zinc, a halogenated alkyl zinc and the like. Examples of the dialkyl zinc include dimethyl zinc, diethyl zinc, di-n-propyl zinc, diisopropyl zinc, di-n-butyl zinc, diisobutyl zinc, di-n-hexyl zinc and the like. Examples of the diaryl zinc include diphenyl zinc, dinaphthyl zinc, bis(pentafluorophenyl)zinc and the like. Examples of the dialkenyl zinc include a diallyl zinc and the like. Examples of the halogenated alkyl zinc include methyl zinc chloride, ethyl zinc chloride, n-propyl zinc chloride, isopropyl zinc chloride, n-butyl zinc chloride, isobutyl zinc chloride, n-hexyl zinc chloride, methyl zinc bromide, ethyl zinc bromide, n-propyl zinc bromide, isopropyl zinc bromide, n-butyl zinc bromide, isobutyl zinc bromide, n-hexyl zinc bromide, methyl zinc iodide, ethyl zinc iodide, n-propyl zinc iodide, isopropyl zinc iodide, n-butyl zinc iodide, isobutyl zinc iodide, n-hexyl zinc iodide and the like.

The compound represented by the formula (2) of the component (a) is preferably the dialkyl zinc, more preferably dimethyl zinc, diethyl zinc, di-n-propyl zinc, diisopropyl zinc, di-n-butyl zinc, diisobutyl zinc or di-n-hexyl zinc, and particularly preferably dimethyl zinc or diethyl zinc.

R⁶ in the formula (3) represents an electron withdrawing group or a group containing an electron withdrawing group and, when there is a plural number of R⁶, they may be the same or different. A substituent constant σ of Hammett s rule is known as an index of electron withdrawing properties, and examples of the electron withdrawing group include functional groups having a positive substituent constant σ of Hammett's rule.

Examples of the electron withdrawing group of R⁶ include a fluorine atom, a chlorine atom, a bromine atom, an iodine atom, a cyano group, a nitro group, a carbonyl group, a sulfone group, a phenyl group and the like. Examples of the group containing an electron withdrawing group of R⁶ include a halogenated alkyl group, a halogenated aryl group, a (halogenated alkyl)aryl group, a cyanated aryl group, a nitrated aryl group, an ester group (an alkoxycarbonyl group, an aralkyloxycarbonyl group, or an aryloxycarbonyl group), an acyl group and the like.

R⁶ is preferably a halogen atom, more preferably a fluorine atom, a chlorine atom, a bromine atom or an iodine atom, and particularly preferably a fluorine atom.

c in the formula (3) represents an integer of 1 to 5.

Examples of the compound represented by the formula (3) of the component (b) include 2-fluorophenol, 3-fluorophenol, 4-fluorophenol, 2,4-difluorophenol, 2,6-difluorophenol, 3,4-difluorophenol, 3,5-difluorophenol, 2,4,6-trifluorophenol, 3,4,5-trifluorophenol, 2,3,5,6-tetrafluorophenol, pentafluorophenol, 2,3,5,6-tetrafluoro-4-trifluoromethylphenol, 2,3,5,6-tetrafluoro-4-pentafluorophenylphenol, perfluoro-1-naphthol, perfluoro-2-naphthol, 2-chlorophenol, 3-chlorophenol, 4-chlorophenol, 2,4-dichlorophenol, 2,6-dichlorophenol, 3,4-dichlorophenol, 3,5-dichlorophenol, 2,4,6-trichlorophenol, 2,3,5,6-tetrachlorophenol, pentachlorophenol, 2,3,5,6-tetrachloro-4-trichloromethylphenol, 2,3,5,6-tetrachloro-4-pentachlorophenylphenol, perchloro-1-naphthol, perchloro-2-naphthol, 2-bromophenol, 3-bromophenol, 4-bromophenol, 2,4-dibromophenol, 2,6-dibromophenol, 3,4-dibromophenol, 3,5-dibromophenol, 2,4,6-tribromophenol, 2,3,5,6-tetrabromophenol, pentabromophenol, 2,3,5,6-tetrabromo-4-tribromomethylphenol, 2,3,5,6-tetrabromo-4-pentabromophenylphenol, perbromo-1-naphthol, perbromo-2-naphthol, 2-iodophenol, 3-iodophenol, 4-iodophenol, 2,4-diiodophenol, 2,6-diiodophenol, 3,4-diiodophenol, 3,5-diiodophenol, 2,4,6-triiodophenol, 2,3,5,6-tetraiodophenol, pentaiodophenol, 2,3,5,6-tetraiodo-4-triiodomethylphenol, 2,3,5,6-tetraiodo-4-pentaiodophenylphenol, periodo-1-naphthol, periodo-2-naphthol, 2-(trifluoromethyl)phenol, 3-(trifluoromethyl)phenol, 4-(trifluoromethyl)phenol, 2,6-bis(trifluoromethyl)phenol, 3,5-bis(trifluoromethyl)phenol, 2,4,6-tris(trifluoromethyl)phenol, 2-cyanophenol, 3-cyanophenol, 4-cyanophenol, 2-nitrophenol, 3-nitrophenol, 4-nitrophenol and the like.

The compound represented by the formula (3) of the component (b) is preferably 3,4,5-trifluorophenol.

SiO₂ of the component (d) is preferably SiO₂ having a uniform particle diameter. The volume-based geometric standard deviation of the particle diameter of SiO₂ of the component (d) is preferably 2.5 or less, more preferably 2.0 or less, and still more preferably 1.7 or less.

The average particle diameter of SiO₂ is usually from 1 to 5000 μm, preferably from 5 to 1000 μm, more preferably from 10 to 500 μm, and still more preferably from 10 to 100 μm. The pore volume is preferably 0.1 ml/g or more, and more preferably from 0.3 to 10 ml/g. The specific surface area is preferably from 10 to 1000 m²/g, and more preferably from 100 to 500 m²/g.

Usually, hydroxyl groups are present on the surface of SiO₂. A modified SiO₂ produced by substituting active hydrogens of the surface hydroxyl groups with various substituents may be used as SiO₂. Examples of the modified SiO₂ include SiO₂ subjected to a contact treatment with a trialkylchlorosilane, a triarylchlorosilane, a dialkyldichlorosilane, a aryldichlorosilane, an alkyltrichlorosilane, an aryltrichlorosilane, a trialkylalkoxysilane, a triarylalkoxysilane, a dialkyldialkoxysilane, a diaryldialkoxysilane, an aryltrialkoxysilane, a tetraalkoxysilane, an alkyldisilazane, a tetrachlorosilane, an alcohol, phenol, a dialkyl magnesium, an alkyl lithium or the like. Examples of the trialkylchlorosilane include trimethylchlorosilane, tert-butyldimethylchlorosilane and the like. Examples of the triarylchlorosilane include triphenylchlorosilane and the like. Examples of the dialkyldichlorosilane include dimethyldichlorosilane and the like. Examples of the diaryldichlorosilane include diphenyldichlorosilane. Examples of the alkyltrichlorosilane include methyltrichlorosilane and the like. Examples of the aryltrichlorosilane include phenyltrichlorosilane and the like. Examples of the trialkylalkoxysilane include trimethylmethoxysilane and the like. Examples of the triarylalkoxysilane include triphenylmethoxysilane and the like. Examples of the dialkyldialkoxysilane include dimethyldimethoxysilane and the like. Examples of the diaryldialkoxysilane include diphenyldimethoxysilane and the like. Examples of the alkyltrialkoxysilane include methyltrimethoxysilane and the like. Examples of the aryltrialkoxysilane include phenyltrimethoxysilane and the like. Examples of the tetraalkoxysilane include tetramethoxysilane and the like. Examples of the alkyldisilazane include 1,1,1,3,3,3-hexamethyldisilazane. Examples of the alcohol include methanol, ethanol and the like. Examples of the dialkyl magnesium include dibutyl magnesium, butylethyl magnesium, butyloctyl magnesium and the like. Examples of the alkyl lithium include butyl lithium and the like.

Further examples include SiO₂ produced by subjecting SiO₂ which has brought into contact with trialkyl aluminum to a contact treatment with a dialkylamine, an alcohol, phenol or the like. Examples of the dialkylamine include diethylamine, diphenylamine and the like. Examples of the alcohol include methanol, ethanol and the like.

The strength of SiO₂ per se may be sometimes increased by the hydrogen bond of hydroxyl groups to each other. In that case, if all active hydrogens of surface hydroxyl groups are substituted by various substituents, a decrease in particle strength may sometimes occur. Therefore, it is not necessarily required to substitute all active hydrogens of surface hydroxyl groups of SiO₂, and the substitution rate of the surface hydroxyl group may be appropriately determined. There is no particular limitation on a method of changing the substitution rate of the surface hydroxyl group. Examples of the method include a method of changing an amount of the compound to be used in the contact treatment of SiO₂.

SiO₂ is preferably dried to substantially remove moisture, and more preferably dried by a heating treatment. The heating treatment of SiO₂ in which moisture cannot be visually confirmed is usually performed at a temperature of from 100 to 1500° C., preferably from 100 to 1000° C., and more preferably from 200 to 800° C. The heating time is preferably from 10 minutes to 50 hours, and more preferably from 1 hour to 30 hours. Examples of the method of drying SiO₂ by heating include a method in which SiO₂ is dried by passing a dried inert gas (e.g., nitrogen, argon, etc.) at a given flow rate while heating, a method in which SiO₂ is pressure-reduced by heating under reduced pressure, and the like.

The component (B) is prepared by bringing the components (a), (b), (c) and (d) into contact with each other. Examples of the order of bringing the components (a), (b), (c) and (d) into contact with each other include the following orders:

<1> an order in which a contact product of (a) and (b) is brought into contact with (c) to obtain a contact product and the obtained contact product is brought into contact with (d);
<2> an order in which a contact product of (a) and (b) is brought into contact with (d) to obtain a contact product and the obtained contact product is brought into contact with (c);
<3> an order in which a contact product of (a) and (c) is brought into contact with (b) to obtain a contact product and the obtained contact product is brought into contact with (d);
<4> an order in which a contact product of (a) and (c) is brought into contact with (d) to obtain a contact product and the obtained contact product is brought into contact with (b);
<5> an order in which a contact product of (a) and (d) is brought into contact with (b) to obtain a contact product and the obtained contact product is brought into contact with (c);
<6> an order in which a contact product of (a) and (d) is brought into contact with (c) to obtain a contact product and the obtained contact product is brought into contact with (b);
<7> an order in which a contact product of (b) and (c) is brought into contact with (a) to obtain a contact product and the obtained contact product is brought into contact with (d);
<8> an order in which a contact product of (b) and (c) is brought into contact with (d) to obtain a contact product and the obtained contact product is brought into contact with (a);
<9> an order in which a contact product of (b) and (d) is brought into contact with (a) to obtain a contact product and the obtained contact product is brought into contact with (c);
<10> an order in which a contact product of (b) and (d) is brought into contact with (c) to obtain a contact product and the obtained contact product is brought into contact with (a);
<11> an order in which a contact product of (c) and (d) is brought into contact with (a) to obtain a contact product and the obtained contact product is brought into contact with (b); and
<12> an order in which a contact product of (c) and (d) is brought into contact with (b) to obtain a contact product and the obtained contact product is brought into contact with (a).

Such a treatment by bringing the components (a), (b), (c) and (d) into contact with each other is preferably carried out under an inert gas atmosphere. The contact temperature is usually from −100 to 300° C., and preferably from −80 to 200° C. The contact time is usually from 1 minute to 200 hours, and preferably from 10 minutes to 100 hours. Such a treatment by bringing the components (a), (b), (c) and (d) into contact with each other may be carried out using a solvent, or these components may be directly brought into contact with each other without using a solvent.

When a solvent is used, a solvent which is inert to the components (a), (b), (c) and (d) and the contact products formed during the above contacting steps is used. However, when the respective compounds are brought into contact with each other in a stepwise manner as described above, a solvent capable of reacting with a certain product formed during a certain step can be used in another step if the solvent does not react with each component in another step. That is, the solvent to be used in each step is the same or different. Examples of the solvent include a nonpolar solvent and a polar solvent.

Examples of the nonpolar solvent include a hydrocarbon solvent and the like. Examples of the hydrocarbon solvent include an aliphatic hydrocarbon solvent and an aromatic hydrocarbon solvent. Examples of the aliphatic hydrocarbon solvent include butane, pentane, hexane, heptane, octane, 2,2,4-trimethylpentane, cyclohexane and the like. Examples of the aromatic hydrocarbon solvent include benzene, toluene, xylene and the like.

Examples of the polar solvent include a halide solvent, an ether-based solvent, an alcohol-based solvent, a phenol-based solvent, a carbonyl-based solvent, a phosphoric acid derivative solvent, a nitrile-based solvent, a nitro compound solvent, an amine-based solvent, a sulfur compound solvent and the like. Examples of the halide solvent include dichloromethane, difluoromethane, chloroform, 1,2-dichloroethane, 1,2-dibromoethane, 1,1,2-trichloro-1,2,2-trifluoroethane, tetrachloroethylene, chlorobenzene, bromobenzene, o-dichlorobenzene and the like. Examples of the ether-based solvent include dimethyl ether, diethyl ether, diisopropyl ether, di-n-butyl ether, methyl-tert-butyl-ether, anisole, 1,4-dioxane, 1,2-dimethoxyethane, bis(2-methoxyethyl)ether, tetrahydrofuran, tetrahydropyran and the like. Examples of the alcohol-based solvent include methanol, ethanol, 1-propanol, 2-propanol, 1-butanol, 2-butanol, 2-methyl-1-propanol, 3-methyl-1-butanol, cyclohexanol, benzyl alcohol, ethylene glycol, propylene glycol, 2-methoxyethanol, 2-ethoxyethanol, diethylene glycol, triethylene glycol, glycerin and the like. Examples of the phenol-based solvent include phenol, p-cresol and the like. Examples of the carbonyl-based solvent include acetone, ethyl methyl ketone, cyclohexanone, acetic anhydride, ethyl acetate, butyl acetate, ethylene carbonate, propylene carbonate, N,N-dimethylformamide, N,N-dimethylacetamide, N-methyl-2-pyrrolidone and the like. Examples of the phosphoric acid derivative solvent include hexamethylphosphoric acid triamide, triethyl phosphate and the like. Examples of the nitrile-based solvent include acetonitrile, propionitrile, succinonitrile, benzonitrile and the like. Examples of the nitro compound solvent include nitromethane, nitrobenzene and the like. Examples of the amine-based solvent include ethylenediamine, pyridine, piperidine, morpholine and the like. Examples of the sulfur compound solvent include dimethyl sulfoxide, sulfolane and the like.

When a contact product (hereinafter, may be described as component (e)) is prepared by bringing the components (a), (b) and (c) into contact with each other in the respective methods of <1>, <3> and <7> described above, a solvent (hereinafter, may be described as solvent (s1)) is preferably the above aliphatic hydrocarbon solvent, the above aromatic hydrocarbon solvent or the above ether-based solvent.

When the component (e) is brought into contact with the component (d), a solvent (hereinafter, may be described as solvent (s2)) is preferably a polar solvent, and more preferably a solvent satisfying 0.8≧E_{T}^{N}≧0.1. The ETN value is an index expressing the polarity of the solvent. The definition of the ETN value is described in C. Reichardt, Solvents and Solvents Effects in Organic Chemistry, 2nd ed., VCH Verlag (1988).

Examples of the polar solvent include dichloromethane, dichlorodifluoromethanechloroform, 1,2-dichloroethane, 1,2-dibromoethane, 1,1,2-trichloro-1,2,2-trifluoroethane, tetrachloroethylene, chlorobenzene, bromobenzene, o-dichlorobenzene, dimethyl ether, diethyl ether, diisopropyl ether, di-n-butyl ether, methyl-tert-butyl ether, anisole, 1,4-dioxane, 1,2-dimethoxyethane, bis(2-methoxyethyl)ether, tetrahydrofuran, tetrahydropyran, methanol, ethanol, 1-propanol, 2-propanol, 1-butanol, 2-butanol, 2-methyl-1-propanol, 3-methyl-1-butanol, cyclohexanol, benzyl alcohol, ethylene glycol, propylene glycol, 2-methoxyethanol, 2-ethoxyethanol, diethylene glycol, triethylene glycol, acetone, ethyl methyl ketone, cyclohexanone, acetic anhydride, ethyl acetate, butyl acetate, ethylene carbonate, propylene carbonate, N,N-dimethylformamide, N,N-dimethylacetamide, N-methyl-2-pyrrolidone, hexamethylphosphoric acid triamide, triethyl phosphate, acetonitrile, propionitrile, succinonitrile, benzonitrile, nitromethane, nitrobenzene, ethylenediamine, pyridine, piperidine, morpholine, dimethyl sulfoxide, sulfolane and the like.

The solvent (s2) is more preferably dimethyl ether, diethyl ether, diisopropyl ether, di-n-butyl ether, methyl-tert-butyl ether, anisole, 1,4-dioxane, 1,2-dimethoxyethane, bis(2-methoxyethyl)ether, tetrahydrofuran, tetrahydropyran, methanol, ethanol, 1-propanol, 2-propanol, 1-butanol, 2-butanol, 2-methyl-1-propanol, 3-methyl-1-butanol, cyclohexanol, benzylalcohol, ethylene glycol, propylene glycol, 2-methoxyethanol, 2-ethoxyethanol, diethylene glycol or triethylene glycol, particularly preferably di-n-butyl ether, methyl-tert-butyl ether, 1,4-dioxane, tetrahydrofuran, methanol, ethanol, 1-propanol, 2-propanol, 1-butanol, 2-butanol, 2-methyl-1-propanol, 3-methyl-1-butanol or cyclohexanol, and most preferably tetrahydrofuran, methanol, ethanol, 1-propanol or 2-propanol.

It is also possible to use, as the solvent (s2), a mixed solvent of a hydrocarbon solvent and a polar solvent. As the hydrocarbon solvent, compounds listed above as the aliphatic hydrocarbon solvents and compounds listed above as the aromatic hydrocarbon solvents are used. Examples of the mixed solvent of the hydrocarbon solvent and the polar solvent include a hexane/methanol mixed solvent, a hexane/ethanol mixed solvent, a hexane/1-propanol mixed solvent, a hexane/2-propanol mixed solvent, a heptane/methanol mixed solvent, a heptane/ethanol mixed solvent, a heptane/1-propanol mixed solvent, a heptane/2-propanol mixed solvent, a toluene/methanol mixed solvent, a toluene/ethanol mixed solvent, a toluene/1-propanol mixed solvent, a toluene/2-propanol mixed solvent, a xylene/methanol mixed solvent, a xylene/ethanol mixed solvent, a xylene/1-propanol mixed solvent, a xylene/2-propanol mixed solvent and the like. The mixed solvent is preferably a hexane/methanol mixed solvent, a hexane/ethanol mixed solvent, a heptane/methanol mixed solvent, a heptane/ethanol mixed solvent, a toluene/methanol mixed solvent, a toluene/ethanol mixed solvent, a xylene/methanol mixed solvent or a xylene/ethanol mixed solvent. The mixed solvent is more preferably a hexane/methanol mixed solvent, a hexane/ethanol mixed solvent, a toluene/methanol mixed solvent or a toluene/ethanol mixed solvent. The mixed solvent is most preferably a toluene/ethanol mixed solvent. An ethanol fraction in the toluene/ethanol mixed solvent is preferably within a range from 10 to 50% by volume, and more preferably from 15 to 30% by volume.

When a hydrocarbon solvent is used as the solvent (s1) and the solvent (s2) in the respective methods of <1>, <3> and <7> described above, the shorter the time until the obtained component (e) is brought into contact with the component (d) after bringing the components (a), (b) and (c) into contact with each other, the better. The time is preferably from 0 to 5 hours, more preferably from 0 to 3 hours, and most preferably from 0 to 1 hour. The temperature at which the component (e) is brought into contact with the component (d) is usually from −100° C. to 40° C., preferably from −20° C. to 20° C., and most preferably from −10° C. to 10° C.

When a solvent is used in the respective methods of <2>, <4>, <5>, <6>, <8>, <9>, <10>, <11> and <12> described above, a nonpolar solvent is preferably used.

When a molar ratio of amounts of the respective components (a), (b) and (c) described above is assumed to be a molar ratio (a):(b):(c)=1:y:z, from the viewpoint that an olefin polymer having a higher molecular weight is obtained and from the viewpoint that a polymerization activity is high, the components (a), (b) and (c) are preferably used so that y and z may satisfy the following formulas (IV), (V) and (VI):

|2−y−2z|≦1 (IV)

z≧−2.5y+2.48 (V)

y<1 (VI)

wherein y and z represent a number more than 0 respectively.

y is preferably from 0.5 to 0.99, more preferably from 0.55 to 0.95, still more preferably from 0.6 to 0.9, and most preferably from 0.7 to 0.8.

The components (a) and (b) are each used in an amount so that the amount of metal atoms derived from the component (a) contained in the component (B) may be preferably 0.1 mmol or more, and more preferably from 0.5 to 20 mmol, expressed by the molar number of the metal atoms per gram of the component (B).

In order to promote the reaction of the respective components, a temperature of a contact product obtained by bringing all components into contact with each other may be raised to a temperature higher than that of the contacting step, after contacting all components. In order to raise the temperature of the contact product, a solvent having a high boiling point is preferably used. Before the temperature of the contact product is raised, the solvent used in the contacting step may be replaced by another solvent having a higher boiling point.

In the component (B), at least one component of the components (a), (b), (c) and (d) as raw materials may remain as an unreacted product. However, the component (B) is preferably washed so as to remove the unreacted product from the component (B). A solvent to be used to wash the component (B) may be the same as or different from that used in the contacting step. The component (B) is preferably washed under an inert gas atmosphere.

It is preferable that the solvent is distilled off from the contact product obtained in the contacting step and from the product obtained in the washing treatment, followed by drying these products at a temperature of 0° C. or higher under reduced pressure for 1 hour to 24 hours. The drying condition is more preferably 0° C. to 200° C. for 1 hour to 24 hours, still more preferably 10° C. to 200° C. for 1 hour to 24 hours, particularly preferably 10° C. to 160° C. for 2 hours to 18 hours, and most preferably 15° C. to 160° C. for 4 hours to 18 hours.

Examples of the organoaluminum compound of the component (c) include a trialkyl aluminum, a dialkyl aluminum chloride, an alkyl aluminum dichloride, a dialkyl aluminum hydride, an alkyl(dialkoxy)aluminum, a dialkyl(alkoxy)aluminum, an alkyl(diaryloxy)aluminum, a dialkyl(aryloxy)aluminum and the like.

Examples of the trialkyl aluminum include trimethyl aluminum, triethyl aluminum, tri-n-propyl aluminum, tri-n-butyl aluminum, triisobutyl aluminum, tri-n-hexyl aluminum, tri-n-octyl aluminum and the like.

Examples of the dialkyl aluminum chloride include dimethyl aluminum chloride, diethyl aluminum chloride, di-n-propyl aluminum chloride, di-n-butyl aluminum chloride, diisobutyl aluminum chloride, di-n-hexyl aluminum chloride and the like.

Examples of the alkyl aluminum dichloride include methyl aluminum dichloride, ethyl aluminum dichloride, n-propyl aluminum dichloride, n-butyl aluminum dichloride, isobutyl aluminum dichloride, n-hexyl aluminum dichloride and the like.

Examples of the dialkyl aluminum hydride include dimethyl aluminum hydride, diethyl aluminum hydride, di-n-propyl aluminum hydride, di-n-butyl aluminum hydride, diisobutyl aluminum hydride, di-n-hexyl aluminum hydride and the like.

Examples of the alkyl(dialkoxy)aluminum include methyl(dimethoxy)aluminum, methyl(diethoxy)aluminum, methyl(di-tert-butoxy)aluminum and the like.

Examples of the dialkyl(alkoxy)aluminum include dimethyl(methoxy)aluminum, dimethyl(ethoxy)aluminum, dimethyl(tert-butoxy)aluminum and the like.

Examples of the alkyl(diaryloxy)aluminum include methyl(diphenoxy)aluminum, methylbis(2,6-diisopropylphenoxy)aluminum, methylbis(2,6-diphenylphenoxy)aluminum and the like.

Examples of the dialkyl(aryloxy)aluminum include dimethyl(phenoxy)aluminum, dimethyl(2,6-diisopropylphenoxy)aluminum, dimethyl(2,6-diphenylphenoxy)aluminum and the like.

These organoaluminum compounds may be used singly or in combination of two or more kinds.

The organoaluminum compound is preferably the trialkyl aluminum, more preferably trimethyl aluminum, triethyl aluminum, tri-n-butyl aluminum, triisobutyl aluminum, tri-n-hexyl aluminum or tri-n-octyl aluminum, and particularly preferably triisobutyl aluminum or tri-n-octyl aluminum.

The molar number of aluminum atoms of the organoaluminum compound per mole of the component (A) is preferably from 0.1 to 1000, more preferably from 0.5 to 500, and further preferably from 1 to 100.

In order to prepare a polymerization catalyst, an electron-donating compound (hereinafter, may be described as component (D)) may be brought into contact with the components (A), (B) and (C). An amount of the component (D) to be used is preferably from 0.01 to 100, more preferably from 0.1 to 50, and further preferably from 0.25 to 5, expressed by the molar number of the component (D) per mole of the component (A). There is no particular limitation on the order of bringing the component (D) and the other components into contact with each other.

Examples of the component (D) include triethylamine, trinormaloctylamine and the like.

The components (A), (B) and (C) and if necessary the component (D) are preferably brought into contact with each other under an inert gas atmosphere. The contact temperature is usually from −100 to 300° C., and preferably from −80 to 200° C. The contact time is usually from 1 minute to 200 hours, and preferably from 30 minutes to 100 hours. The respective components may be separately supplied in a polymerization reaction tank to bring them into contact with each other therein.

Examples of the method for producing the ethylene-α-olefin copolymer of the present invention include a gas phase polymerization method, a slurry polymerization method, a bulk polymerization method and the like. A gas phase polymerization method is preferably, and a continuous gas phase polymerization method is more preferable. A gas phase polymerization reaction apparatus to be used in the polymerization method is usually an apparatus having a fluidized bed type reaction tank, and preferably an apparatus having a fluidized bed type reaction tank having an enlarged part. A stirring blade may also be installed in the polymerization reaction tank.

As the method of feeding the respective components used to form the polymerization catalyst or the polymerization catalyst obtained by bringing the respective components into contact with each other to a polymerization reaction tank, a method of chaging under anhydrous state using an inert gas such as nitrogen or argon, and hydrogen, ethylene and the like, or a method in which the respective components or the polymerization catalyst are/is dissolved in or diluted with a solvent and charged in the form of solution or slurry, is usually used.

When ethylene and an α-olefin are polymerized in a gas phase polymerization method, the polymerization temperature is lower than the melting temperature of the ethylene-α-olefin copolymer to be produced, preferably from 0° C. to 150° C., and more preferably from 30° C. to 100° C. An inert gas, or hydrogen as a molecular weight modifier may be added into the polymerization reaction tank. The component (D) may be added into the polymerization reaction tank.

Examples of the α-olefin having 3 to 20 carbon atoms used for polymerization include propylene, 1-butene, 1-pentene, 1-hexene, 1-heptene, 1-octene, 1-nonene, 1-decene, 1-dodecene, 4-methyl-1-pentene, 4-methyl-1-hexene and the like. They may be used singly or in combination of two or more kinds. The α-olefin is preferably 1-butene, 1-hexene, 4-methyl-1-pentene or 1-octene. Examples of the combination of ethylene and the α-olefin having 3 to 20 carbon atoms include an ethylene/1-butene combination, an ethylene/1-hexene combination, an ethylene/4-methyl-1-pentene combination, an ethylene/1-octene combination, an ethylene/1-butene/1-hexene combination, an ethylene/1-butene/4-methyl-1-pentene combination, an ethylene/1-butene/1-octene combination, an ethylene/1-hexene/1-octene combination and the like. The combination is preferably an ethylene/1-butene combination, an ethylene/1-hexene combination, an ethylene/4-methyl-1-pentene combination, an ethylene/1-butene/1-hexene combination, an ethylene/1-butene/1-octene combination or an ethylene/1-hexene/1-octene combination.

When ethylene and an α-olefin are copolymerized, another monomer may be added in the range not deteriorating the effect of the present invention into a polymerization reaction tank, and then another monomer, ethylene and the α-olefin may be copolymerized. Examples of another monomer include a diolefin, a cyclic olefin, an alkenylaromatic hydrocarbon, an α,β-unsaturated carboxylic acid, a metal salt of an α,β-unsaturated carboxylic acid, an α,β-unsaturated carboxylic acid alkyl ester, an unsaturated dicarboxylic acid, a vinyl ester, an unsaturated carboxylic acid glycidyl ester and the like.

Examples of the diolefin include 1,5-hexadiene, 1,4-hexadiene, 1,4-pentadiene, 1,7-octadiene, 1,8-nonadiene, 1,9-decadiene, 4-methyl-1,4-hexadiene, 5-methyl-1,4-hexadiene, 7-methyl-1,6-octadiene, 5-ethylidene-2-norbornene, dicyclopentadiene, 5-vinyl-2-norbornene, 5-methyl-2-norbornene, norbornadiene, 5-methylene-2-norbornene, 1,5-cyclooctadiene, 5,8-endomethylenehexahydronaphthalene, 1,3-butadiene, isoprene, 1,3-hexadiene, 1,3-octadiene, 1,3-cyclooctadiene, 1,3-cyclohexadiene and the like.

Examples of the cyclic olefin include norbornene, 5-methylnorbornene, 5-ethylnorbornene, 5-butylnorbornene, 5-phenylnorbornene, 5-benzylnorbornene, tetracyclododecene, tricyclodecene, tricycloundecene, pentacyclopentadecene, pentacyclohexadecene, 8-methyltetracyclododecene, 8-ethyltetracyclododecene, 5-acetylnorbornene, 5-acetyloxynorbornene, 5-methoxycarbonylnorbornene, 5-ethoxycarbonylnorbornene, 5-methyl-5-methoxycarbonylnorbornene, 5-cyanonorbornene, 8-methoxycarbonyltetracyclododecene, 8-methyl-8-tetracyclododecene, 8-cyanotetracyclododecene and the like.

Examples of the alkenylaromatic hydrocarbon include an alkenylbenzene such as styrene, 2-phenylpropylene, 2-phenylbutene and 3-phenylpropylene, an alkylstyrene such as p-methylstyrene, m-methylstyrene, o-methylstyrene, p-ethylstyrene, m-ethylstyrene, o-ethylstyrene, 2,4-dimethylstyrene, 2,5-dimethylstyrene, 3,4-dimethylstyrene, 3,5-dimethylstyrene, 3-methyl-5-ethylstyrene, p-tert-butylstyrene and p-sec-butylstyrene, a bisalkenylbenzene such as divinylbenzene, an alkenylnaphthalene such as 1-vinylnaphthalene, and the like.

Examples of the α,β-unsaturated carboxylic acid include acrylic acid, methacrylic acid, fumaric acid, maleic anhydride, itaconic acid, itaconic anhydride, bicyclo(2,2,1)-5-heptene-2,3-dicarboxylic acid and the like.

Examples of the metal salt of the α,β-unsaturated carboxylic acid include a sodium salt, a potassium salt, a lithium salt, a zinc salt, a magnesium salt or a calcium salt of the above-mentioned α,β-unsaturated carboxylic acids, and the like.

Examples of the α,β-unsaturated carboxylic acid alkyl ester include methyl acrylate, ethyl acrylate, n-propyl acrylate, isopropyl acrylate, t-butyl acrylate, 2-ethylhexyl acrylate, methyl methacrylate, ethyl methacrylate, n-propyl methacrylate, isopropyl methacrylate, n-butyl methacrylate, isobutyl methacrylate and the like.

Examples of the unsaturated dicarboxylic acid include maleic acid, itaconic acid and the like. Examples of the vinyl ester include vinyl acetate, vinyl propionate, vinyl caproate, vinyl caprate, vinyl laurate, vinyl stearate, vinyl trifluoroacetate and the like

Examples of the unsaturated carboxylic acid glycidyl ester include glycidyl acrylate, glycidyl methacrylate, itaconic acid monoglycidyl ester and the like.

In the method for producing an ethylene-α-olefin copolymer according to the present invention, an olefin can be polymerized using a prepolymerizd catalyst obtained by polymerizing (hereinafter referred to as prepolymerizing) a small amount of an olefin using a polymerization catalyst obtained from the components (A), (B) and (C) and if necessary the component (D).

Examples of the olefin to be used in the prepolymerization include ethylene, propylene, 1-butene, 1-pentene, 1-hexene, 1-octene, 4-methyl-1-pentene, cyclopentene, cyclohexene and the like. They may be used singly or in combination of two or more kinds. Preferably, ethylene is singly used or ethylene and an α-olefin are used together, further preferably, ethylene is singly used or ethylene and at least one α-olefin selected from 1-butene, 1-hexene and 1-octene are used together.

A content of the prepolymerized polymer in the prepolymerized catalyst is preferably from 0.01 to 1000 g, more preferably from 0.05 to 500 g, and further preferably from 0.1 to 200 g, per gram of the component (B) used to prepare the prepolymerized catalyst.

The prepolymerization method may be a continuous polymerization method or a batch-wise polymerization method, and examples thereof include a batch-wise slurry polymerization method, a continuous slurry polymerization method and a continuous gas phase polymerization method. As a method of charging the components (A), (B) and (C) and if necessary the component (D) into a polymerization reaction tank for carrying out a prepolymerization, a method of chaging under anhydrous state using an inert gas such as nitrogen or argon, and hydrogen, ethylene and the like, or a method in which the respective components are dissolved in or diluted with a solvent and charged in the form of solution or slurry, is usually used.

In the case of carrying out the prepolymerization by a slurry polymerization method, a saturated hydrocarbon compound is usually used as the solvent, and examples thereof include propane, n-butane, isobutane, n-pentane, isopentane, n-hexane, cyclohexane, heptane and the like. They are used singly or in combination of two or more kinds. The saturated hydrocarbon compound is preferably that having a boiling point at normal pressure of 100° C. or less, more preferably that having a boiling point at normal pressure of 90° C. or less, and further preferably propane, n-butane, isobutane, n-pentane, isopentane, n-hexane or cyclohexane.

The slurry concentration is usually from 0.1 to 600 g, and preferably from 0.5 to 300 g, in terms of the amount of the component (B) per liter of the solvent. The prepolymerization temperature is usually from −20 to 100° C., and preferably from 0 to 80° C. The partial pressure of olefins in a gas phase portion during the prepolymerization is usually from 0.001 to 2 MPa, and preferably from 0.01 to 1 MPa. The prepolymerization time is usually from 2 minutes to 15 hours.

As a method of charging the prepolymerized catalyst into a polymerization reaction tank, a method of chaging under anhydrous state using an inert gas such as nitrogen or argon, and hydrogen, ethylene and the like, or a method in which the prepolymerized catalyst is dissolved in or diluted with a solvent and charged in the form of solution or slurry, is usually used.

The ethylene-α-olefin copolymer of the present invention may contain a known additive if needed. Examples of the additive include antioxidants, weathering agents, lubricants, anti-blocking agents, antistatic agents, antifogging agents, anti-dripping agents, pigments, fillers and the like.

The resin composition of the present invention may contain a thermoplastic resin and/or a thermoplastic elastomer different from the ethylene-α-olefin copolymer of the present invention, if needed. Examples of the thermoplastic resin or the thermoplastic elastomer include a high pressure polymerized low-density polyethylene, a linear low-density polyethylene, a high-density polyethylene, a medium-density polyethylene, an ultralow-density polyethylene, an ethylene-(meth)acrylic acid copolymer, a metal salt of an ethylene-(meth)acrylic acid copolymer, polypropylene; a styrene-based resin such as polystyrene, an ABS resin, a styrene-butadiene block copolymer and the hydride thereof and a styrene-isoprene block copolymer and the hydride thereof; polyesters such as polyethylene terephthalate and polybutylene terephthalate; polyamides such as nylon 6, nylon 66, nylon 11, nylon 12 and nylon 6□66; polycarbonate, polymethylmethacrylate, polyacetal, polyphenylenesulfide, an ethylene-propylene rubber, a styrene-based thermoplastic elastomer, an olefin-based thermoplastic elastomer, a polyester-based thermoplastic elastomer, a polyurethane-based thermoplastic elastomer, a polyamide-based thermoplastic elastomer and the like. In the present invention, a polymer contained in a resin composition is sometimes referred to as a resin material. When a resin composition only contains the ethylene-α-olefin copolymer of the present invention as a polymer, a resin material is the ethylene-α-olefin copolymer. When a resin composition contains the ethylene-α-olefin copolymer of the present invention and also a thermoplastic resin and/or a thermoplastic elastomer other than the ethylene-α-olefin copolymer of the present invention, the resin material is the mixture of the ethylene-α-olefin copolymer of the present invention and the thermoplastic resin and/or the thermoplastic elastomer.

Particularly, when a cross-linked foam obtained in the present invention or a pressurized cross-linked foam described later is used for shoe soles or shoe sole members, a resin composition used for producing the cross-linked foam preferably contains an ethylene-unsaturated ester-based copolymer such as ethylene-vinyl acetate copolymer, since adhesion to another member such as rubber or a vinyl chloride sheet is often needed. When the resin composition of the preset invention contains an ethylene-unsaturated ester-based copolymer, a content of the ethylene-unsaturated ester-based copolymer is preferably from 25 to 900 parts by weight, and more preferably from 40 to 400 parts by weight, assuming that the ethylene-α-olefin copolymer of the present invention is 100 parts by weight.

The resin composition for producing a foam of the preset invention comprises a resin material containing the above ethylene-α-olefin copolymer for foaming and a thermally decomposable foaming agent having a decomposition temperature of 120 to 240° C. There is no particular limitation on the thermally decomposable foaming agent, and a known thermally decomposable foaming agent may be used. A plurality of the thermally decomposable foaming agents may be used together.

Examples of the thermally decomposable foaming agent include ammonium carbonate, sodium carbonate, ammonium hydrogen carbonate, sodium hydrogen carbonate, ammonium nitrite, sodium borohydride, an inorganic foaming agent such as monosodium citrate anhydrous; an organic foaming agent such as azodicarbonamide, barium azodicarboxylate, azobisisobutyronitrile, nitroguanidine, N,N′-dinitropentamethylenetetramine, N,N′-dimethyl-N,N′-dinitrosoterephthalamide, p-toluenesulfonylhydrazide, p-toluenesulfonylsemicarbazide, 4,4′-oxybisbenzenesulfonylhydrazide, azobisisobutyronitrile, 4,4′-oxybisbenzenesulfonylsemicarbazide, 5-phenyltetrazole, trihydrazinotriazine and hydrazodicarbonamide, and the like. Among them, azodicarbonamide, sodium hydrogen carbonate or 4,4′-oxybisbenzenesulfonylhydrazide is preferably used from the viewpoint of economic efficiency. A foaming agent containing azodicarbonamide and sodium hydrogen carbonate is particularly preferably used, since it causes a wide molding temperature range and a cross-linked foam having fine bubble structure is obtained.

The thermally decomposable foaming agent in the present invention has a decomposition temperature of 120 to 240° C. The decomposition temperature of the thermally decomposable foaming agent is obtained according to a method based on JIS K0064. When a thermally decomposable foaming agent having a decomposition temperature higher than 200° C. is used, the decomposition temperature is preferably lowered to 200° C. or less by co-using a foaming aid. Examples of the foaming aid include a metal oxide such as zinc oxide and lead oxide; a metal carbonate such as zinc carbonate; a metal chloride such as zinc chloride; urea; a metal soap such as zinc stearate, lead stearate, dibasic lead stearate, zinc laurate, zinc 2-ethylhexanoate and dibasic lead phthalate; an organotin compound such as dibutyltin dilaurate and dibutyltin dimaleate; inorganic salts such as tribasic lead sulfate, dibasic lead phosphite and basic lead sulfite; and the like.

As the thermally decomposable foaming agent, a masterbatch comprising a thermally decomposable foaming agent, a foaming aid and a resin may be used. There is no particular limitation on kinds of resins used for the masterbatch as far as the effect of the present invention is not impaired. An ethylene-α-olefin copolymer contained in a resin composition of the present invention, or a high pressure polymerized low-density polyethylene is preferable. A total amount of the thermally decomposable foaming agent and the foaming aid contained in the masterbatch is usually from 5 to 100 parts by weight, assuming that a resin contained in the masterbatch is 100 parts by weight.

In order to obtain a foam having finer bubble structure, a foaming nucleator is preferably used in combination with a foaming agent. Examples of the foaming nucleator include an inorganic filler such as talc, silica, mica, zeolite, calcium carbonate, calcium silicate, magnesium carbonate, aluminum hydroxide, barium sulfate, aluminosilicate, clay, quartz powder and diatomite; beads having a particle size of 100 μm or less and consisting of polymethylmethacrylate or polystyrene; a metal salt such as calcium stearate, magnesium stearate, zinc stearate, sodium benzoate, calcium benzoate, aluminum benzoate and magnesium oxide. They may be used in combination of two or more kinds.

The resin composition for producing a foam of the present invention comprises 100 parts by weight of a resin material and preferably 1 to 80 parts by weight, more preferably 10 to 70 parts by weight, relative to 100 parts by weight of the resin material, of a thermally decomposable foaming agent.

The resin composition of the present invention may comprise an organic peroxide besides the resin material and the thermally decomposable foaming agent. The organic peroxide preferably has a one-minute half-life temperature higher than a flow starting temperature of the resin material contained in the resin composition. Examples of the organic peroxide include dicumyl peroxide, 1,1-di-tert-butylperoxy-3,3,5-trimethylcyclohexane, 2,5-dimethyl-2,5-di-tert-butylperoxyhexane, 2,5-dimethyl-2,5-di-tert-butylperoxyhexine, α,α di-tert-butylperoxyisopropylbenzene, tert-butylperoxyketone, tert-butylperoxybenzoate and the like. A content of the organic peroxide is usually from 0.02 to 3 parts by weight, preferably from 0.05 to 1.5 parts by weight, assuming that the total amount of the resin material contained in the resin composition is 100 parts by weight.

Preferable is the organic peroxide having a one-minute half-life temperature of 120 to 220° C., and more preferable is the organic peroxide having a one-minute half-life temperature of 140 to 190° C.

The flow starting temperature of the resin material mentioned herein is defined as a temperature lower by 10° C. than a temperature at a position of the highest temperature melting peak among melting peaks, which are observed using a differential scanning calorimeter Model DSC-7 manufactured by Perkin Elmer, when 8 to 12 mg of a sample is filled into an aluminum pan, and held at 150° C. for 2 minutes, the temperature is lowered to 40° C. at a rate of 5° C./minute, the sample is held at 40° C. for 2 minutes and, thereafter, the temperature is raised to 150° C. at a rate of 5° C./minute.

The resin composition of the present invention may comprise a cross-linking aid. As the cross-linking aid, a compound having a plurality of double-bonds in its molecule is preferably used. Examples of the cross-linking aid include N,N′-m-phenylenebismaleimide, toluoylenebismaleimide, triallylisocyanurate, triallylcyanurate, p-quinonedioxime, nitrobenzene, diphenylguanidine, divinylbenzene, ethyleneglycoldimethacrylate, polyethyleneglycoldimethacrylate, trimethylolpropanetrimethacrylate, trimethylolpropanetriacrylate, allylmethacrylate and the like. These cross-linking aids may be used in combination of two or more kinds.

An amount of the cross-linking aid in the resin composition is usually from 0.01 to 4.0 parts by weight, preferably from 0.05 to 2.0 parts by weight, relative to 100 parts by weight of the resin material contained in the resin composition.

The resin composition of the present invention may comprise a foaming aid. Examples of the foaming aid include a compound containing urea as a main component; a metal oxide such as zinc oxide and lead oxide; a higher fatty acid such as salicylic acid and stearic acid; a metal compound of the higher fatty acid; and the like. The foaming aid is used in an amount of preferably from 0.1 to 30% by weight, and more preferably from 1 to 20% by weight, assuming that the total amount of the foaming agent and the foaming aid is 100% by weight.

The resin composition of the present invention may comprise various additives such as a thermal stabilizer, a weathering agent, a lubricant, an antistatic agent, a filler, a pigment (a metal oxide such as zinc oxide, titanium oxide, calcium oxide, magnesium oxide and silicon oxide; a carbonate such as magnesium carbonate and calcium carbonate; a fibrous material such as pulp; and the like), and a flame retardant.

As a material for producing a cross-linked foam, suitable is the resin composition comprising the resin material containing the ethylene-α-olefin copolymer of the present invention, and the thermally decomposable foaming agent, and the resin composition comprising the resin material containing the ethylene-α-olefin copolymer of the present invention, the thermally decomposable foaming agent and the organic peroxide. First, a method for producing the cross-linked foam with ionizing radiation is explained.

### <Method for Producing Electron Beam Cross-Linked Foam>

First, ionizing radiation is applied to any of the above resin compositions to form a cross-linked intermediate (i). The resin composition to be used may be a resin composition obtained by kneading respective components in advance. It is preferable to use a sheet-like resin composition obtained by kneading respective components in advance. When the respective components are kneaded, the components may be kneaded at a temperature at which the thermally decomposable foaming agent is not decomposed, and the resin material is plasticized. When a resin composition obtained by kneading the ethylene-α-olefin copolymer, the thermally decomposable foaming agent and the organic peroxide in advance is used, it is preferable to knead the respective components so that a cross-linking reaction with the organic peroxide may not proceed while the respective components are kneaded. After completion of the kneading step, a cross-linking reaction with the organic peroxide may proceed.

A shape of the cross-linked intermediate (i) is not particularly limited. Examples of a method of obtaining a sheet-shaped intermediate (i) include a method of molding the resin composition into a sheet with a calendar roll, a method of molding the resin composition into a sheet with a press molding machine, a method of molding the resin composition into a sheet by extruding it through a flat die or a circular die, and the like. It is preferable that a kneading temperature is lower than the decomposition temperature of the thermally decomposable foaming agent by 50° C. or greater, and is higher than the flow starting temperature of the resin material. A temperature for kneading the respective components is preferably from 100 to 150° C., and more preferably from 110 to 140° C.

Examples of ionizing radiation include an α-ray, a β-ray, a γ-ray, an electron beam, a neutron beam, an x-ray and the like. Among them, a γ-ray of cobalt-60, or an electron beam is preferable. When the intermediate (i) is a sheet-shaped intermediate, ionizing radiation may be applied to at least one side of the intermediate (i).

Application of ionizing radiation is performed using a known ionizing radiation application apparatus, and an application amount is usually from 5 to 300 kGy, and preferably from 30 to 200 kGy. When the resin composition of the present invention is used, a cross-linked foam excellent in an expansion ratio can be produced at a small radiation application amount as compared with the case where a cross-linked foam is produced using a previous resin composition for foaming.

Then, the cross-linked intermediate (i) is heated, and thereby the cross-linked intermediate (i) is expanded to form a cross-linked foam.

As a method of heating the cross-linked intermediate (i) to expand it, a known method can be utilized, and a method which can continuously heat-expand the cross-linked intermediate (ii) such as a vertical hot air expansion method, a horizontal hot air expansion method, and a horizontal drug liquid expansion method is preferable. A temperature at which the intermediate (i) is heated may be a temperature at which the thermally decomposable foaming agent is decomposed, or higher, and preferably a temperature higher than the decomposition temperature of the thermally decomposable foaming agent by 5 to 50° C. The temperature at which the intermediate (i) is heated is preferably from 100 to 150° C., and more preferably from 110 to 140° C. A heating time is usually from 3 to 7 minutes, when the cross-linked intermediate (i) is heated with an oven.

When a resin composition comprising the ethylene-α-olefin copolymer, the thermally decomposable foaming agent and the organic peroxide is used, a temperature at which the intermediate (i) is heated is preferably a temperature of a one-minute half-life temperature of the organic peroxide ±30° C.

The cross-linked foam obtained by the method comprising the step of applying ionizing radiation to the resin composition may be referred to as an electron beam cross-linked foam.

### <Method for Producing Organic Peroxide Cross-Linked Foam>

Then, another method for producing a cross-linked foam using a resin composition comprising a resin material containing the ethylene-α-olefin copolymer of the present invention, the thermally decomposable foaming agent and the organic peroxide is described.

The method comprises the following steps:

a step of feeding the resin composition into a mold,

a step of pressurizing and heating the resin composition in the mold to form a plasticized and cross-linked intermediate (ii), and

a step of expanding the intermediate (ii) by opening the mold to form a cross-linked foam.

It is preferable that the resin composition to be fed into the mold is a resin composition obtained by performing the following treatment in advance.

First, it is preferable that a mixture of the resin material, the thermally decomposable foaming agent and the organic peroxide is plasticized with a mixing roll, a kneader, an extruder or the like at a temperature which is equal to or lower than the decomposition temperature of the thermally decomposable foaming agent, equal to or lower than the one-minute half-life temperature of the organic peroxide, and equal to or higher than the flow starting temperature of the resin material. A temperature at which the mixture is plasticized is preferably from 90 to 150° C., more preferably from 100 to 140° C., and further preferably from 105 to 120° C. The plasticized mixture is cooled to obtain a resin composition. The resulting resin composition is fed into a mold.

The resin composition in the mold is pressurized and heated with a press machine or the like to form a plasticized and cross-linked intermediate (ii). It is preferable that a temperature at which the resin composition is heated is equal to or higher than the one-minute half-life temperature of the organic peroxide, equal to or higher than the decomposition temperature of the thermally decomposable foaming agent, and equal to or higher than a melting point of the resin material. A temperature at which the resin composition is heated is preferably from 130 to 220° C., more preferably from 140 to 190° C., and further preferably from 150 to 180° C. The melting point of the resin material mentioned herein is defined as a temperature at a position of the highest temperature melting peak among melting peaks, which are observed using a differential scanning calorimeter Model DSC-7 manufactured by Perkin Elmer, when 8 to 12 mg of a sample is filled into an aluminum pan, and held at 150° C. for 2 minutes, the temperature is lowered to 40° C. at a rate of 5° C./minute, the sample is held at 40° C. for 2 minutes and, thereafter, the temperature is raised to 150° C. at a rate of 5° C./minute.

A mold closing pressure of the mold is preferably from 50 to 300 kgf/cm², and a pressure keeping time is preferably around 10 to 60 minutes.

Then, when the mold is opened, the intermediate (ii) is expanded, and a cross-linked foam can be obtained.

Then, another method for producing a cross-linked foam using a resin composition comprising a resin material containing the ethylene-α-olefin copolymer of the present invention, the thermally decomposable foaming agent and the organic peroxide is described.

The method comprises the following steps:

a step of pressurizing and heating the resin composition to form a plasticized intermediate (iii),

a step of feeding the plasticized intermediate (iii) into a mold and cross-linking the intermediate (iii) by pressurizing and heating the intermediate (iii) in the mold to form a plasticized and cross-linked intermediated (iv), and

a step of expanding the intermediate (iv) by opening the mold to form a cross-linked foam.

The step of forming a plasticized intermediate (iii) can be performed in a cylinder of an injection-molding machine. It is preferable that a temperature at which the resin composition is heated is equal to or higher than the flow starting temperature of the resin material, equal to or lower than the decomposition temperature of the thermally decomposable foaming agent, and equal to or lower than the one-minute half-life temperature of the organic peroxide. A temperature at which the resin composition is heated is preferably from 90 to 150° C., more preferably from 100 to 140° C., and further preferably from 105 to 120° C.

The intermediate (iii) is fed into a mold, and the intermediate (iii) in the mold is pressurized and heated, thereby the intermediate (iii) is cross-linked to form a plasticized and cross-linked intermediate (iv). It is preferable that a temperature of the mold be equal to or higher than the melting point of the resin material, equal to or higher than the one-minute half-life temperature of the organic peroxide, and equal to or higher than the decomposition temperature of the thermally decomposition foaming agent. A temperature of the mold is preferably from 130 to 220° C., more preferably from 140 to 210° C., and further preferably from 150 to 200° C. A mold closing pressure of the mold is preferably from 50 to 300 kgf/cm², and a pressure keeping time is preferably around 10 to 60 minutes.

Finally, the intermediate (iv) is expanded by opening the mold to obtain a cross-linked foam.

The cross-linked foam obtained by any of the aforementioned methods using the resin composition comprising the resin material, the thermally decomposable foaming agent and the organic peroxide may be also referred to as an organic peroxide cross-linked foam. The organic peroxide cross-linked foam can be further pressurized to obtain a pressurized cross-linked foam. Usually, by applying a load of 30 to 200 kg/cm² to the organic peroxide cross-linked foam at 130 to 200° C. for 5 to 60 minutes, the pressurized cross-linked foam is obtained. The pressurized cross-linked foam of the present invention is more preferable for a midsole which is one kind of members for footwear.

The organic peroxide cross-linked foam or the pressurized cross-liked foam of the present invention may be used by cutting into a desired shape, or may be used after buffing.

The organic peroxide cross-linked foam or the pressurized cross-linked foam of the present invention may be formed into a multilayered laminate by laminating with other layers. Examples of materials constituting the other layers include a vinyl chloride resin material, a styrene-based copolymer rubber material, an olefin-based copolymer rubber material (an ethylene-based copolymer rubber material, a propylene-based copolymer rubber material, etc.), a natural leather material, an artificial leather material, a cloth material and the like, and at least one material of these materials is used.

Examples of a method for producing these multilayered laminates include a method of laminating the organic peroxide cross-linked foam or the pressurized cross-linked foam to other layers which have been separately molded, with heat, with a chemical adhesive or the like. As the chemical adhesive, known chemical adhesives can be used. Among them, particularly, a urethane-based chemical adhesive, a chloroprene-based chemical adhesive or the like is preferable. In addition, upon lamination with these chemical adhesives, an undercoating agent referred to as a primer may coat the other layers and/or the cross-linked foam in advance.

The organic peroxide cross-linked foam and the pressurized cross-linked foam obtained by the method of the present invention exhibit good fatigue resistance. For this reason, a layer comprising the organic peroxide cross-linked foam or the pressurized cross-linked foam, or a multilayered molded product in which the above layer and the other layers are laminated can be suitably used as a member of footwear such as shoes and sandals. Examples of the member for footwear include midsoles, outersoles, insoles and the like. Alternatively, the organic peroxide cross-linked foam and the pressurized cross-linked foam can be also used in building materials such as a heat insulating material and a buffer material.

By using the ethylene-α-olefin copolymer of the present invention and a physical foaming agent as a material, and extruding or injecting the material, a non cross-linked foam can be obtained.

Examples of the physical foaming agent include steams of low boiling organic solvents such as methanol, ethanol, propane, butane and pentane; steams of halogenated inert solvents such as dichloromethane, chloroform, carbon tetrachloride, fluorocarbon and nitrogen trifluoride; inert gases such as carbon dioxide, nitrogen, argon, helium, neon and astatine.

Alternatively, the non cross-linked foam can be obtained by extruding, injecting or press-molding the resin composition of the present invention comprising a resin material containing the ethylene-α-olefin copolymer, and the thermally decomposable foaming agent.

By using the resin composition of the present invention comprising the resin material containing the ethylene-α-olefin copolymer, and the thermally decomposable foaming agent, and the physical foaming agent as a material, and extruding, injecting or press-molding the material, the non cross-linked foam can be obtained. In this case, it is preferable that an amount of the thermally decomposable foaming agent contained in the resin composition is 0.1 to 5 parts by weight relative to 100 parts by weight of the resin material.

The non cross-linked foam and the ionizing radiation cross-linked foam which are obtained using a material containing the ethylene-α-olefin copolymer of the present invention are preferably used in a buffer material, a heat insulating material, a sound insulating material, a low-temperature insulation or the like.

### EXAMPLES

The present invention is explained below by the Examples.

Properties in the Examples were measured according to the following methods.

(1) Density (d, in kg/m³)

The density was measured according to the A method of JIS K7112-1980. A sample was annealed according to JIS K6760-1995.

(2) Melt Flow Rate (MFR, in g/10 minutes)

The melt flow rate was measured under a load of 21.18 N at a temperature of 190° C. according to the A method of JIS K7210-1995.

### (3) Melt Flow Rate Ratio (MFRR)

MFRR was obtained by dividing the melt flow rate (H-MFR) measured under a load of 211.82 N at a temperature of 190° C. according to the method of JIS K7210-1995 by the melt flow rate (MFR) measured under a load of 21.18 N at a temperature of 190° C. according to the method of JIS K7210-1995.

### (4) Swell Ratio (SR)

In the measurement of the melt flow rate of (2), a strand of an ethylene-α-olefin copolymer which had been extruded at a length of around 15 to 20 mm from an orifice under the conditions of a temperature of 190° C. and a load of 21.18N was cooled in air to obtain a solid strand. Then, a diameter D (in mm) of the strand at a position of about 5 mm from a tip on an extrusion upstream side of the strand was measured, and a value (D/D₀) obtained by dividing the diameter D by an orifice diameter of 2.095 mm (D₀) was calculated, and used as a swell ratio.

### (5) Molecular Weight Distribution (Mw/Mn)

A weight average molecular weight (Mw) and a number average molecular weight (Mn) were measured with a gel permeation chromatography (GPC) method under the following conditions (1) to (8) to determine a molecular weight distribution (Mw/Mn). A base line in a chromatogram was set as a straight line, of which a point in a stable horizontal region with a retention time sufficiently shorter than that of a sample elution peak initially appeared was connected with a point in a stable horizontal region with a retention time sufficiently longer than that of a solvent elution peak finally observed.

(1) Instrument: Waters 150C, manufactured by Waters Co., Ltd.

(2) Separation column: TOSOH TSK gel GMH6-HT

(3) Measurement temperature: 140° C.

(4) Carrier: ortho-dichlorobenzene

(5) Flow rate: 1.0 ml/minute

(6) Injected amount: 500 μl

(7) Detector: differential refractometer

(8) Standard substance for molecular weight: Standard polystyrene (6) Number of long branches (N_{LCB}, in 1/1000 C)

A carbon nuclear magnetic resonance spectrum (¹³C-NMR) was measured under the following measurement conditions by a carbon nuclear magnetic resonance method, and the number of long branches was obtained by the following calculation method.

### <Measurement Condition>

Apparatus: AVANCE 600, manufactured by Bruker
Measurement solvent: Mixed liquid of
1,2-dichlorobenzene/1,2-dichlorobenzene-d4=75/25 (volumetric ratio)
Measurement temperature: 130° C.
Measurement method: Proton decoupling method
Pulse width: 45 degree
Pulse repetition time: 4 seconds
Measurement standard: Trimethylsilane
Window function: Negative exponential function

### <Calculation Method>

The peak areas of peaks having a peak top at around 38.22 to 38.27 ppm were obtained, assuming that a sum of areas of all peaks observed at 5 to 50 ppm is 1000. The peak area of the peak was an area of signals in a range from a chemical shift of a valley between a peak on the highest magnetic field side in the above range and a peak adjoining the peak on a side which is higher magnetic field than the peak, to a chemical shift of a valley between a peak on the lowest magnetic field side in the range and a peak adjoining the peak on a side which is lower magnetic field than the peak. In the measurement of the ethylene-α-olefin copolymer under the present conditions, a position of a peak top of peaks derived from methine carbon to which a branch having a carbon atom number of 5 is bonded, was 38.21 ppm.

(7) Activation Energy of Flow (Ea, in kJ/mol)

Melt complex viscosities and angular frequencies at 130° C., 150° C., 170° C. and 190° C. were measured under the following conditions using a viscoelasticity measuring apparatus (Rheometrics Mechanical Spectrometer RMS-800, manufactured by Rheometrics, Ltd.) to prepare a melt complex viscosity-angular frequency curve. From the obtained curve, a master curve of melt complex viscosity-angular frequency at 190° C. was prepared using a computer software Rhios V.4.4.4 (manufactured by Rheometrics, Ltd.) and the activation energy (Ea) was determined.

### <Measurement Condition>

Geometry: parallel plate

Plate diameter: 25 mm

Plate distance: 1.5 to 2 mm

Strain: 5%

Angular frequency: 0.1 to 100 rad/minute

Measurement atmosphere: nitrogen

(8) g*

g* was obtained according to the following formula (I):

g*=[η]/([η]_{GPC}×g_{SCB}*) (I)

wherein [η] is the intrinsic viscosity (in dl/g) of the ethylene-α-olefin copolymer and is defined by the following formula (I-I), [η]_{GPC} is defined by the following formula (I-II), and g^{SCB}* is defined by the following formula (I-III):

[η]=23.3×log(ηᵣₑₗ) (I-I)

wherein ηᵣₑₗ is the relative viscosity of the ethylene-α-olefin copolymer,

[η]_{GPC}=0.00046×Mv^{0.725} (I-II)

wherein Mv is the viscosity average molecular weight of the ethylene-α-olefin copolymer,

g_{SCB}*=(1−A)^{1.725} (I-III)

wherein A is determined from the content of short branches in the ethylene-α-olefin copolymer.

[η]_{GPC} represents the intrinsic viscosity (in dl/g) of an ethylene polymer assuming that the polymer has the same molecular weight distribution as a molecular weight distribution of an ethylene-α-olefin copolymer for which g* is measured, and has a linear molecular chain.

g_{SCB}* represents contribution to g* which is generated by the presence of short branches in the ethylene-α-olefin copolymer.

As the formula (I-II), the formula described in L. H. Tung, Journal of Polymer Science, 36, 130 (1959), pp. 287-294 is used.

A relative viscosity (ηrel) of the ethylene-α-olefin copolymer is calculated from a fall time of a sample solution measured using an Ubbelohde viscometer, the sample solution being prepared by dissolving 100 mg of the ethylene-α-olefin copolymer in 100 ml of a tetralin solution containing 5% by weight of butylhydroxytoluene (BHT) as a heat deterioration preventing agent at 135° C., and a fall time of a blank solution containing a tetralin solution containing only 0.5% by weight of BHT as the heat deterioration preventing agent.

A viscosity average molecular weight (Mv) of the ethylene-α-olefin copolymer is defined by the following formula (I-IV):

$${M}_{V} = {( \frac{{\sum }_{μ = 1}^{∞} {M}_{μ}^{a + 1} {n}_{μ}}{{\sum }_{μ = 1}^{∞} {M}_{μ} {n}_{μ}} )}^{1 / a} \qquad ( I - IV )$$

wherein a=0.725. Herein, the molecular number of a molecular weight M_{μ} is expressed by n_{μ}.

A in the formula (I-III) is estimated as:

A=((12×n+2n+1)×y)/((1000−2y−2)×14+(y+2)×15+y×13)

when the number of carbon atoms contained in a short branch is defined as n, and the number of short branches per 1000 of the number of carbon atoms obtained by NMR or infrared spectrometry is defined as y.

The number of the short branches in the ethylene-α-olefin copolymer was obtained from an infrared absorption spectrum. The measurement and calculation were performed utilizing characteristic absorption derived from an α-olefin according to the method described in the literature (Die Makromoleculare Chemie, 177, 449 (1976) McRae, M. A., Madams, W. F.). The infrared absorption spectrum of the ethylene-α-olefin copolymer was measured using an infrared spectrophotometer (FT-IR7300, manufactured by JASCO Corporation).

### (9) Elongational Viscosity

An 18 mm×10 mm sheet having a thickness of 0.7 mm, which was obtained by press-molding a sample, was used as a test piece.

Using an elongational viscosity measuring devise (ARES, manufactured by TA Instruments), an elongational viscosity-time curve of the test piece at 130° C. was measured at a Hencky rate of 0.1 s⁻¹ and 1 s⁻¹. The measurement was performed under a nitrogen atmosphere.

A slope of ln α(t) at t of between 1.2 seconds to 1.7 seconds, for a curve:

α(t)=σ₁(t)/σ_{0.1}(t) (5)

obtained by dividing an elongational viscosity-time carve σ₁(t) of a sample when the sample is monoaxially stretched at a strain rate of 1 s⁻¹ at a Hencky strain measured at 130° C. by an elongational viscosity-time curve σ_{0.1}(t) of a sample when the sample is monoaxially stretched at a strain rate of 0.1 s⁻¹ at a Hencky strain measured at 130° C., was used as an elongational viscosity nonlinear index k.

### (10) Melt Tension (MT, in cN)

Using a melt tension tester manufactured by Toyo Seiki Seisaku-Sho, Ltd., an ethylene-α-olefin copolymer was melt-extruded from an orifice of a diameter of 2.095 mm and a length of 8 mm at a temperature of 190° C. and an extrusion rate of 0.32 g/minute, the extruded and molten ethylene-α-olefin copolymer was taken-up into a filament with a take-up roll at a take-up increasing rate of 6.3 (m/minute)/minute, and a tension was measured. The maximum tension during from initiation of take-up to breakage of the filament-like ethylene-α-olefin copolymer was used as a melt tension.

(11) Density of Electron Beam Cross-Linked Foam (d, in kg/m³)

The density was measured according to the method as defined in the A method of JIK K7112-1980. A foam sample was not annealed.

### (12) Expansion Ratio of Electron Beam Cross-Linked Foam (in Fold)

The expansion ratio was calculated from the density of a resin obtained by the method of the above (1) Density and the foam density obtained in the above (11), according to the following formulation.

Expansion ratio=density of resin/density of foam

(13) Tensile Impact Strength of Electron Beam Cross-Linked Foam (in kJ/m²)

A test piece was punched out into a S-type dumbbell shape described in ASTM D1822-61T, the test piece was fixed on a tensile testing machine (CIT-150T-20, manufactured by A&D Company Ltd.) so that a distance between chucks might become 20 mm, and a test was performed at a prescribed rate (hammer angle of 150°). From measured data, a stress-strain amount curve was prepared with a strain amount as the x-axis against a stress as the y-axis, and a breakage energy (in kJ) was obtained from an area of a portion surrounded with a straight line which passes through an end point of the stress-strain amount curve (point at breakage) and is parallel with the y-axis (straight line having a strain amount of 0), the X-axis (straight line at a stress of 0), and the stress-strain amount curve, using the resulting stress strain amount curve. In addition, a cross-sectional area (in m²) of a portion, which is smallest in a width of the test piece before the test, was obtained, and a tensile breakage strength (in kJ/m²) was obtained from the cross-sectional area and the breakage energy. The test was performed at 23° C.

(14) Density of Organic Peroxide Cross-Linked Foam (in kg/m³)

The density was measured according to ASTM-D 297. As this value is smaller, a lightweight property is excellent.

### (15) Skin-Off Hardness of Organic Peroxide Cross-Linked Foam (No Unit)

Using a slicer for a food (HBC-2 Type, manufactured by NANTSUNE Co., Ltd.), a skin by 2 mm was peeled from a surface (skin-on side) of the cross-linked foam. A side which becomes a surface by peeling a skin may be referred to as a skin-off side. Regarding the skin-off side, the skin-off hardness was measured with a C method durometer according to ASTM-D 2240.

### (16) Compression Set of Organic Peroxide Cross-Linked Foam (in %)

A cross-linked foam was cut to obtain a 2.5 cm×2.5 cm×1.0 cm sample. A thickness of the sample was compressed from 1.0 cm to 5 mm, and the sample was allowed to stand in an oven adjusted at 50° C. for 6 hours while the state was maintained. After decompression, the sample was allowed to stand at room temperature for 30 minutes. Thereafter, a thickness t [mm] of the sample was measured, and a compression set was obtained according to the following formula. Four samples were measured, and an average of the four values was used as a measured value. As this value is smaller, fatigue resistance is excellent.

Compression set (%)={(10−t)/(10−5)}×100

### Polymerization Example 1

### (1) Preparation of Solid Catalyst Component (B)

To a nitrogen-substituted reactor with a stirrer were added 2.8 kg of silica (Sylopol 948, manufactured by Davison Co., Ltd.; 50% volume average particle diameter=55 μm; pore volume=1.67 ml/g; specific surface area=325 m²/g) heat-treated at 300° C. under a stream of nitrogen and 24 kg of toluene. The mixture was stirred and then the reactor was cooled to 5° C. Thereafter, a mixed solution of 1,1,1,3,3,3-hexamethyldisilazane (0.9 kg) and toluene (1.4 kg) was added dropwise over 30 minutes while keeping a reactor temperature of 5° C. After completion of the dropping, the component in the reactor was stirred at 5° C. for 1 hour, raised to 95° C., stirred at 95° C. for 3 hours and then filtered. The obtained solid product was washed six times with each 20.8 kg of toluene. Then, 7.1 kg of toluene was added to the washed solid product to form a slurry, which was allowed to stand overnight.

To the obtained slurry in the reactor were added 1.73 kg of a solution of diethyl zinc in hexane (concentration of diethyl zinc: 50% by weight) and 1.02 kg of hexane, which was stirred to obtain a mixture. The mixture was then cooled to 5° C., to which a mixed solution of 3,4,5-trifluorophenol (0.78 kg) and toluene (1.44 kg) was added dropwise over 60 minutes while keeping a reactor temperature of 5° C. After completion of the dropping, the component in the reactor was stirred at 5° C. for 1 hour, raised to 40° C. and stirred at 40° C. for 1 hour. Then, the component in the reactor was cooled to 22° C., to which 0.11 kg of water was added over 1.5 hour while keeping a reactor temperature of 22° C. After completion of the dropping, the component in the reactor was stirred at 22° C. for 1.5 hours, raised to 40° C., stirred at 40° C. for 2 hours, raised to 80° C., stirred at 80° C. for 2 hours to obtain a slurry. The supernatant liquid of the slurry was taken out at room temperature to yield 16 L of the slurry, to which 11.6 kg of toluene was added. The mixture was raised to 95° C. and stirred for 4 hours to obtain a slurry. The supernatant liquid was taken out at room temperature to yield a solid product. The obtained solid product was washed four times with each 20.8 kg of toluene and three times with each 24 L of hexane. Then, the washed solid product was dried to obtain a solid catalyst component (B).

### (2) Polymerization

After reduced-pressure drying, an argon-substituted autoclave (inner volume of 3 L) with a stirrer was evacuated, to which hydrogen was added so that the partial pressure thereof might become 0.001 MPa. Then, 30 g of 1-butene as a comonomer and 720 g of butane as a polymerization solvent were added into the autoclave, and the temperature in the autoclave was raised to 70° C. Then, ethylene as a monomer was added so that the partial pressure thereof might become 1.6 MPa, and the system was stabilized. As a result of gas chromatographic analysis, the gas composition in the system was as follows: hydrogen=0.035 mol %, 1-butene=3.38 mol %. 0.9 ml of a solution of triisobutyl aluminum (C) in hexane (concentration: 1 mol/L) was added thereto. Then, 0.25 ml of a solution of dimethylsilylenebis(3-phenylcyclopentadienyl)zirconiumdichloride (A) (racemic/meso ratio=49.2/50.8) in toluene (concentration: 2 μmol/ml) was added, and 5.1 mg of the solid catalyst component (B) obtained in the above Example 1 (1) was added. While feeding an ethylene gas so as to maintain a constant entire pressure in the autoclave, ethylene and 1-butene were copolymerized at 70° C. for 1 hour. As a result, 35 g of an ethylene-1-butene copolymer was obtained. The obtained copolymer was kneaded with a roll so as to obtain a uniform copolymer, and its properties were evaluated. The result of the properties evaluation of the kneaded and obtained copolymer was shown in Table 1.

### Polymerization Example 2

### (1) Polymerization

After reduced-pressure drying, an argon-substituted autoclave (inner volume of 3 L) with a stirrer was evacuated, to which hydrogen was added so that the partial pressure thereof might become 0.002 MPa. Then, 100 ml of 1-hexene and 650 g of butane as a polymerization solvent were added into the autoclave, and the temperature in the autoclave was raised to 70° C. Then, ethylene was added so that the partial pressure thereof might become 1.6 MPa, and the system was stabilized. As a result of gas chromatographic analysis, the gas composition in the system was as follows: hydrogen=0.09 mol %. 0.9 ml of a solution of triisobutyl aluminum in hexane, the concentration of which had been adjusted to 1 mol/L, as the organoaluminum compound (C) was added thereto. Then, 1 ml of a solution of dimethylsilylenebis(3-phenylcyclopentadienyl)zirconiumdichloride (A) (racemic/meso ratio=49.2/50.8) in toluene, the concentration of which had been adjusted to 1 μmol/ml, was added, and 8.3 mg of the solid catalyst component obtained in the above Polymerization Example 1 (1) was added. While an ethylene/hydrogen mixed gas (hydrogen=0.07 mol %) was continuously fed during polymerization, ethylene and 1-hexene were copolymerized at 70° C. for 60 minutes. Then, butane, ethylene and hydrogen were purged to obtain 65 g of an ethylene-1-hexene copolymer. The obtained copolymer was roll-kneaded in the same manner as in Polymerization Example 1. The result of the properties evaluation of the kneaded and obtained copolymer was shown in Table 1.

### Polymerization Example 3

### (1) Polymerization

After reduced-pressure drying, an argon-substituted autoclave (inner volume of 3 L) with a stirrer was evacuated, to which hydrogen was added so that the partial pressure thereof might become about 0.004 MPa. Then, 100 ml of 1-hexene and 650 g of butane as a polymerization solvent were added into the autoclave, and the temperature in the autoclave was raised to 70° C. Then, ethylene was added so that the partial pressure thereof might become 1.6 MPa, and the system was stabilized. As a result of gas chromatographic analysis, the gas composition in the system was as follows: hydrogen=0.17 mol %. 0.9 ml of a solution of triisobutyl aluminum in hexane (concentration: 1 mol/L) as the organoaluminum compound (C) was added thereto. Then, 1 ml of a solution of dimethylsilylenebis(3-phenylcyclopentadienyl)zirconiumdichloride (A) (racemic/meso ratio=49.2/50.8) in toluene (concentration: 1 μmol/ml) was added, and 15.3 mg of the solid catalyst component obtained in the above Polymerization Example 1 (1) was added. While an ethylene/hydrogen mixed gas (hydrogen=0.04 mol %) was continuously fed during polymerization, ethylene and 1-hexene were copolymerized at 70° C. for 60 minutes. Then, butane, ethylene and hydrogen were purged to obtain 113 g of an ethylene-1-hexene copolymer. The obtained copolymer was roll-kneaded in the same manner as in Polymerization Example 1. The result of the properties evaluation of the kneaded and obtained copolymer was shown in Table 1.

### Polymerization Example 4

### (1) Polymerization

After reduced-pressure drying, an argon-substituted autoclave (inner volume of 3 L) with a stirrer was evacuated, to which hydrogen was added so that the partial pressure thereof might become about 0.004 MPa. Then, 100 ml of 1-hexene and 650 g of butane as a polymerization solvent were added into the autoclave, and the temperature in the autoclave was raised to 70° C. Then, ethylene was added so that the partial pressure thereof might become 1.6 MPa, and the system was stabilized. As a result of gas chromatographic analysis, the gas composition in the system was as follows: hydrogen=0.24 mol %. 0.9 ml of a solution of triisobutyl aluminum in hexane, the concentration of which had been adjusted to 1 mol/L, as the organoaluminum compound (C) was added thereto. Then, 1 ml of a solution of dimethylsilylenebis(3-phenylcyclopentadienyl)zirconiumdichloride (A) (racemic/meso ratio=49.2/50.8) in toluene (concentration: 1 μmol/ml) was added, and 6.2 mg of the solid catalyst component obtained in the above Polymerization Example 1 (1) was added. While an ethylene/hydrogen mixed gas (hydrogen=0.09 mol %) was continuously fed during polymerization, ethylene and 1-hexene were copolymerized at 70° C. for 60 minutes. After completion of the polymerization, the gas composition in the system was as follows: hydrogen=0.28 mol %. Then, butane, ethylene and hydrogen were purged to obtain 33 g of an ethylene-1-hexene copolymer. The obtained copolymer was roll-kneaded in the same manner as in Polymerization Example 1. The result of the properties evaluation of the kneaded and obtained copolymer was shown in Table 1.

### Polymerization Example 5

### (1) Polymerization

After reduced-pressure drying, an argon-substituted autoclave (inner volume of 3 L) with a stirrer was evacuated, to which hydrogen was added so that the partial pressure thereof might become about 0.007 MPa. Then, 100 ml of 1-hexene and 650 g of butane as a polymerization solvent were added into the autoclave, and the temperature in the autoclave was raised to 70° C. Then, ethylene was added so that the partial pressure thereof might become 1.6 MPa, and the system was stabilized. As a result of gas chromatographic analysis, the gas composition in the system was as follows: hydrogen=0.31 mol %. 0.9 ml of a solution of triisobutyl aluminum in hexane (concentration: 1 mol/L) as the organoaluminum compound (C) was added thereto. Then, 1 ml of a solution of dimethylsilylenebis(3-phenylcyclopentadienyl)zirconiumdichloride (A) (racemic/meso ratio=49.2/50.8) in toluene (concentration: 1 μmol/ml) was added, and 7.0 mg of the solid catalyst component obtained in the above Polymerization Example 1 (1) was added. While an ethylene/hydrogen mixed gas (hydrogen=0.07 mol %) was continuously fed during polymerization, ethylene and 1-hexene were copolymerized at 70° C. for 60 minutes. Then, butane, ethylene and hydrogen were purged to obtain 48 g of an ethylene-1-hexene copolymer. The obtained copolymer was roll-kneaded in the same manner as in Polymerization Example 1. The result of the properties evaluation of the kneaded and obtained copolymer was shown in Table 1.

### Polymerization Example 6

### (1) Polymerization

After reduced-pressure drying, an argon-substituted autoclave (inner volume of 3 L) with a stirrer was evacuated, to which hydrogen was added so that the partial pressure thereof might become about 0.009 MPa. Then, 100 ml of 1-hexene and 650 g of butane as a polymerization solvent were added into the autoclave, and the temperature in the autoclave was raised to 70° C. Then, ethylene was added so that the partial pressure thereof might become 1.6 MPa, and the system was stabilized. As a result of gas chromatographic analysis, the gas composition in the system was as follows: hydrogen=0.42 mol %. 0.9 ml of a solution of triisobutyl aluminum in hexane (concentration: 1 mol/L) as the organoaluminum compound (C) was added thereto. Then, 1 ml of a solution of dimethylsilylenebis(3-phenylcyclopentadienyl)zirconiumdichloride (A) (racemic/meso ratio=49.2/50.8) in toluene (concentration: 1 μmol/ml) was added, and 10.3 mg of the solid catalyst component obtained in the above Polymerization Example 1 (1) was added. While an ethylene/hydrogen mixed gas (hydrogen=0.07 mol %) was continuously fed during polymerization, ethylene and 1-hexene were copolymerized at 70° C. for 60 minutes. Then, butane, ethylene and hydrogen were purged to obtain 54 g of an ethylene-1-hexene copolymer. The obtained copolymer was roll-kneaded in the same manner as in Polymerization Example 1. The result of the properties evaluation of the kneaded and obtained copolymer was shown in Table 1.

### Polymerization Example 7

### (1) Polymerization

After reduced-pressure drying, an argon-substituted autoclave (inner volume of 3 L) with a stirrer was evacuated, to which hydrogen was added so that the partial pressure thereof might become 0.001 MPa. Then, 60 ml of 1-hexene and 650 g of butane as a polymerization solvent were added into the autoclave, and the temperature in the autoclave was raised to 70° C. Then, ethylene was added so that the partial pressure thereof might become 0.8 MPa, and the system was stabilized. As a result of gas chromatographic analysis, the gas composition in the system was as follows: hydrogen=0.06 mol %. 0.9 ml of a solution of triisobutyl aluminum in hexane (concentration: 1 mol/L) as the organoaluminum compound (C) was added thereto. Then, 1 ml of a solution of dimethylsilylenebis(3-phenylcyclopentadienyl)zirconiumdichloride (A) (racemic/meso ratio=49.2/50.8) in toluene (concentration: 1 μmol/ml) was added, and 13 mg of the solid catalyst component obtained in the above Polymerization Example 1 (1) was added. While an ethylene/hydrogen mixed gas (hydrogen=0.05 mol %) was continuously fed during polymerization, ethylene and 1-hexene were copolymerized at 70° C. for 60 minutes. Then, butane, ethylene and hydrogen were purged to obtain 37 g of an ethylene-1-hexene copolymer. The obtained copolymer was roll-kneaded in the same manner as in Polymerization Example 1. The result of the properties evaluation of the kneaded and obtained copolymer was shown in Table 1.

### Polymerization Example 8

### (1) Polymerization

After reduced-pressure drying, an argon-substituted autoclave (inner volume of 3 L) with a stirrer was evacuated, to which hydrogen was added so that the partial pressure thereof might become 0.002 MPa. Then, 55 g of 1-butene as a comonomer and 695 g of butane as a polymerization solvent were added into the autoclave, and the temperature in the autoclave was raised to 70° C. Then, ethylene as a monomer was added so that the partial pressure thereof might become 1.6 MPa, and the system was stabilized. As a result of gas chromatographic analysis, the gas composition in the system was as follows: hydrogen=0.032 mol %, 1-butene=2.74 mol %. 0.9 ml of a solution of triisobutyl aluminum in hexane (concentration: 1 mol/L) as the organoaluminum compound (C) was added thereto. Then, 0.75 ml of a solution of dimethylsilylenebis(3-phenylcyclopentadienyl)zirconiumdichloride (racemic/meso ratio=49.2/50.8) in toluene, the concentration of which had been adjusted to 2 μmol/ml, as the transition metal compound (A) was added, and 15.2 mg of the solid catalyst component (B) obtained in the above Polymerization Example 1 (1) was added. While feeding an ethylene gas so as to maintain a constant entire pressure in the autoclave, ethylene and 1-butene were copolymerized at 70° C. for 1 hour. As a result, 119 g of an ethylene-1-butene copolymer was obtained. The obtained copolymer was roll-kneaded in the same manner as in Polymerization Example 1. The result of the properties evaluation of the kneaded and obtained copolymer was shown in Table 2.

### Polymerization Example 9

### (1) Polymerization

After reduced-pressure drying, an argon-substituted autoclave (inner volume of 3 L) with a stirrer was evacuated, to which hydrogen was added so that the partial pressure thereof might become 0.002 MPa. Then, 55 g of 1-butene as a comonomer and 695 g of butane as a polymerization solvent were added into the autoclave, and the temperature in the autoclave was raised to 70° C. Then, ethylene as a monomer was added so that the partial pressure thereof might become 1.6 MPa, and the system was stabilized. As a result of gas chromatographic analysis, the gas composition in the system was as follows: hydrogen=0.096 mol %, 1-butene=2.90 mol %. 0.9 ml of a solution of triisobutyl aluminum in hexane (concentration: 1 mol/L) as the organoaluminum compound (C) was added thereto. Then, 0.75 ml of a solution of dimethylsilylenebis(3-phenylcyclopentadienyl)zirconiumdichloride (racemic/meso ratio=49.2/50.8) in toluene (concentration: 2 μmol/ml) as the transition metal compound (A) was added. Thereafter, 0.9 ml of triethylamine in toluene (concentration: 0.1 mol/L) as the electron donating compound (D) was added, and then 9.0 mg of the solid catalyst component (B) obtained in the above Polymerization Example 1 (1) was added. While feeding an ethylene gas so as to maintain a constant entire pressure in the autoclave, ethylene and 1-butene were copolymerized at 70° C. for 1 hour. As a result, 40 g of an ethylene-1-butene copolymer was obtained. The obtained copolymer was roll-kneaded in the same manner as in Polymerization Example 1. The result of the properties evaluation of the copolymer obtained after roll-kneading was shown in Table 2.

### Comparative Polymerization Example 1

### (1) Preparation of Solid Catalyst Component

To a nitrogen-substituted reactor with a stirrer was added 9.68 kg of silica (Sylopol 948, manufactured by Davison Co., Ltd.) heat-treated at 300° C. under a stream of nitrogen. After addition of 100 L of toluene, the reactor was cooled to 2° C. 26.3 L of a solution of methyl aluminoxane in toluene (2.9 M) was added dropwise over 1 hour while keeping a reactor temperature of 2° C. After the component in the reactor was stirred at 5° C. for 30 minutes, the reactor was heated to 95° C. over 90 minutes, and the component was further stirred at 95° C. for 4 hours. Then, the reactor was cooled to 40° C., and allowed to stand for 40 minutes for the sedimentation of a solid component, and a slurry part of its upper layer was taken out. A washing step was performed, in which 100 L of toluene was added to the solid component, the mixture was stirred for 10 minutes, the stir was stopped, the mixture was allowed to stand for the sedimentation of a solid component, and a slurry part of its upper layer was taken out. The washing step was performed three times in total. After 100 L of toluene was added and the mixture was stirred, the component in the reactor was filtered as soon as the stir was stopped. This step was repeated once more to obtain a solid component. After 110 L of hexane was added to the solid component and the mixture was stirred, the component in the reactor was filtered as soon as the stir was stopped. This step was repeated once more to obtain a solid component. Then, the solid component was dried under a stream of nitrogen at 70° C. for 7 hours to obtain 12.6 kg of a solid catalyst component. As a result of elemental analysis of the solid catalyst component, Al was 4.4 mmol/g.

### (2) Preparation of Solid Polymerization Catalyst

To a four-necked flask (inner volume of 200 ml) with a stirrer substituted with nitrogen were added 7.7 g of the solid catalyst component obtained in Comparative Polymerization Example 1 (1) and 50 ml of toluene to form a slurry. To the slurry was added 38 ml of rasemic-dimethylsilylenebis(2-methyl-1-indenyl)zirconiumdichloride (concentration: 5.3 μmol/ml) and 2.6 ml of meso-dimethylsilylenebis(2-methyl-1-indenyl)zirconiumdichloride (concentration: 2.5 μmol/ml) (racemic/meso ratio=96.9/3.1), and the mixture was stirred at room temperature for 1 hour. The obtained slurry was dried under reduced pressure at 50° C. for 9 hours to obtain 7.8 g of a solid polymerization catalyst.

### (3) Polymerization

After reduced-pressure drying, an autoclave (inner volume of 3 L) equipped with a stirrer was argon-substituted, to which 32.6 g of NaCl dried under reduced pressure at 140° C. for 6 hours was added. Then, the autoclave was evacuated, and hydrogen was added so that the partial pressure thereof might become 0.017 MPa, 6 g of 1-butene as a comonomer was added, and the temperature in the autoclave was raised to 70° C. Then, ethylene as a monomer was added so that the pressure in the autoclave might become 2.0 MPa, and the system was stabilized. As a result of gas chromatographic analysis, the gas composition in the system was as follows: hydrogen=0.80 mol %, 1-butene=4.75 mol %. 0.3 ml of a solution of triisobutyl aluminum in hexane, the concentration of which had been adjusted to 1 mol/L, as the organoaluminum compound (C) was added thereto. Then, 42.7 mg of the solid polymerization catalyst prepared in Comparative Example 3 (2) was added. While an ethylene/hydrogen/1-butene mixed gas (hydrogen=0.50 mol %, 1-butene=5.0 mol %) was continuously fed so as to maintain a constant entire pressure in the autoclave, and a constant hydrogen concentration and a constant 1-butene concentration in the gas during polymerization, ethylene and 1-butene were copolymerized at 70° C. for 2 hours. As a result, 56 g of an ethylene-1-butene copolymer was obtained. The obtained copolymer was roll-kneaded in the same manner as in Production Example 1. The result of the properties evaluation of the kneaded and obtained copolymer was shown in Table 2.

### Comparative Polymerization Example 2

### (1) Preparation of Solid Catalyst Component

To a nitrogen-substituted reactor with a stirrer was added 9.68 kg of silica (Sylopol 948, manufactured by Davison Co., Ltd.) heat-treated at 300° C. under a stream of nitrogen. After addition of 100 L of toluene, the reactor was cooled to 2° C. 26.3 L of a solution of methyl aluminoxane in toluene (2.9 M) was added dropwise over 1 hour while keeping a reactor temperature of 2° C. After the component in the reactor was stirred at 5° C. for 30 minutes, the reactor was heated to 95° C. over 90 minutes, and the component was further stirred at 95° C. for 4 hours. Then, the reactor was cooled to 40° C., and allowed to stand for 40 minutes for the sedimentation of a solid component, and a slurry part of its upper layer was taken out. A washing step was performed, in which 100 L of toluene was added to the obtained solid component, the mixture was stirred for 10 minutes, the stir was stopped, the mixture was allowed to stand for the sedimentation of a solid component, and a slurry part of its upper layer was taken out. The washing step was performed three times in total. After 100 L of toluene was added and the mixture was stirred, the component in the reactor was filtered as soon as the stir was stopped. This step was repeated once more to obtain a solid component. After 110 L of hexane was added to the solid component and the mixture was stirred, the component in the reactor was filtered as soon as the stir was stopped. This step was repeated once more to obtain a solid component. Then, the solid component was dried under a stream of nitrogen at 70° C. for 7 hours to obtain 12.6 kg of a solid catalyst component. As a result of elemental analysis of the solid catalyst component, Al was 4.4 mmol/g.

### (2) Preparation of Slurry Catalyst Component

To a nitrogen-substituted glass flask (inner volume of 100 ml) were added 12.5 ml of a solution of dimethylsilanediylbis(cyclopentadienyl)zirconiumdichloride in toluene (concentration: 2 μmol/ml) and 1 ml of a solution of diphenylmethylene(1-cyclopentadienyl)(9-fluorenyl)zirconiumdichloride in toluene (concentration: 2 μmol/ml). Then, 200 mg of the solid catalyst component prepared in the above (1) was added thereto to allow the components to react with each other at room temperature for 5 minutes. After that, the supernatant liquid was taken out by decantation, the residue was washed twice with hexane, and hexane was added to the washed residue to obtain 6 ml of a hexane-slurry.

### (3) Polymerization

After reduced-pressure drying, an argon-substituted autoclave (inner volume of 3 L) with a stirrer was evacuated, to which 180 ml of 1-hexene and 650 g of butane as a polymerization catalyst were added. The temperature in the autoclave was raised to 70° C. Then, an ethylene/hydrogen mixed gas (hydrogen=0.33 mol %) was added so that the partial pressure of the mixed gas might become 1.6 MPa, and the system was stabilized. As a result of gas chromatographic analysis, the gas composition in the system was as follows: hydrogen=0.15 mol %. 0.9 ml of a solution of triisobutyl aluminum in hexane (concentration: 1 mol/L) as the organoaluminum compound (C) was added to the autoclave. Then, 6 ml of the slurry catalyst component prepared in the above (2) was added. While an ethylene/hydrogen mixed gas (hydrogen=0.33 mol %) was continuously fed during polymerization, ethylene and 1-hexene were copolymerized at 70° C. for 60 minutes. After that, butane, ethylene and hydrogen were purged to obtain 71 g of an ethylene-1-hexene copolymer. The obtained copolymer was roll-kneaded in the same manner as in Production Example 1. The result of the properties evaluation of the kneaded and obtained copolymer was shown in Table 2.

TABLE 1

| | | Polymeri- | Polymeri- | Polymeri- | Polymeri- | Polymeri- | Polymeri- | Polymeri- |
|---|---|---|---|---|---|---|---|---|
| | | zation | zation | zation | zation | zation | zation | zation |
| | | Example 1 | Example 2 | Example 3 | Example 4 | Example 5 | Example 6 | Example 7 |
| Density | kg/m³ | 922 | 921 | 923 | 922 | 926 | 925 | 918 |
| MFR | g/10 min | 0.34 | 0.9 | 1.9 | 3.7 | 13.1 | 19.6 | 0.44 |
| MFRR | — | 190 | 74 | 55 | 46 | 37 | 35 | 73 |
| SR | — | 1.83 | 1.88 | 1.80 | 1.80 | 1.77 | 1.65 | 1.76 |
| N_{LCB} | 1/1000 C. | 0.46 | 0.34 | 0.36 | 0.34 | 0.29 | 0.23 | 0.36 |
| Molecular | — | 5.3 | 6.3 | 6.5 | 5.4 | 5.9 | 5.4 | 5.9 |
| Weight | | | | | | | | |
| Distribution | | | | | | | | |
| Mw/Mn | | | | | | | | |
| Ea | kJ/mol | 76 | 67 | 63 | 59 | 55 | 55 | 71 |
| g* | — | 0.61 | 0.70 | 0.70 | 0.73 | 0.75 | 0.74 | 0.70 |
| k | — | —* | 0.92 | 1.02 | 1.00 | 0.87 | 0.80 | —* |
| MT | cN | 30.3 | 20.9 | 8.0 | 4.0 | 1.0 | 0.6 | 25.6 |

—* not determined

TABLE 2

| | | | | Comparative | Comparative |
|---|---|---|---|---|---|
| | | Polymerization | Polymerization | Polymerization | Polymerization |
| | | Example 8 | Example 9 | Example 1 | Example 2 |
| Density | kg/m³ | 921 | —* | 918 | 920 |
| MFR | g/10 min | 0.41 | 3.2 | 2.2 | 3.0 |
| MFRR | — | 90 | 50 | 50 | 109 |
| SR | — | 1.64 | 2.03 | 1.75 | 2.48 |
| N_{LCB} | 1/1000 C. | 0.49 | 0.46 | 0 | 0 |
| Molecular | — | 6.2 | 10.3 | 6.4 | 11.0 |
| Weight | | | | | |
| Distribution | | | | | |
| Mw/Mn | | | | | |
| Ea | kJ/mol | 56 | 67 | 66 | 48 |
| g* | — | 0.66 | 0.64 | 0.93 | 0.895 |
| k | — | —* | —* | 0.61 | 1.34 |
| MT | cN | —* | —* | 5.5 | 15.4 |

—* not determined

### Example 1

### (1) Preparation of Solid Catalyst Component (B)

To a nitrogen-substituted reactor with a stirrer were added 2.8 kg of silica (Sylopol 948, manufactured by Davison Co., Ltd.; 50% volume average particle diameter=55 μm; pore volume=1.67 ml/g; specific surface area=325 m²/g) heat-treated at 300° C. under a stream of nitrogen and 24 kg of toluene. The mixture was stirred and then the reactor was cooled to 5° C. Thereafter, a mixed solution of 1,1,1,3,3,3-hexamethyldisilazane (0.9 kg) and toluene (1.4 kg) was added dropwise over 30 minutes while keeping a reactor temperature of 5° C. After completion of the dropping, the component in the reactor was stirred at 5° C. for 1 hour, raised to 95° C., stirred at 95° C. for 3 hours and then filtered. The obtained solid product was washed six times with each 20.8 kg of toluene. Then, 7.1 kg of toluene was added to the washed solid product to form a slurry, which was allowed to stand overnight.

To the obtained slurry were added 1.73 kg of a solution of diethyl zinc in hexane (concentration of diethyl zinc: 50% by weight) and 1.02 kg of hexane, which was stirred to obtain a mixture. The mixture was then cooled to 5° C., to which a mixed solution of 3,4,5-trifluorophenol (0.78 kg) and toluene (1.44 kg) was added dropwise over 60 minutes while keeping a reactor temperature of 5° C. After completion of the dropping, the component in the reactor was stirred at 5° C. for 1 hour, raised to 40° C. and stirred at 40° C. for 1 hour. Then, the component in the reactor was cooled to 22° C., to which 0.11 kg of water was added over 1.5 hour while keeping a reactor temperature of 22° C. After completion of the dropping, the component in the reactor was stirred at 22° C. for 1.5 hours, raised to 40° C., stirred at 40° C. for 2 hours, raised to 80° C., stirred at 80° C. for 2 hours to obtain a slurry. The supernatant liquid of the slurry was taken out at room temperature to yield 16 L of the slurry, to which 11.6 kg of toluene was added. The mixture was raised to 95° C. and stirred for 4 hours to obtain a slurry. The supernatant liquid was taken out from the slurry at room temperature to yield a solid product. The obtained solid product was washed four times with each 20.8 kg of toluene and three times with each 24 L of hexane. Then, the washed solid product was dried to obtain a solid catalyst component (B).

### (2) Polymerization

After reduced-pressure drying, an argon-substituted autoclave (inner volume of 3 L) with a stirrer was evacuated, to which hydrogen was added so that the partial pressure thereof might become 0.003 MPa. 120 ml of 1-hexene and 650 g of butane as a polymerization solvent were added thereto, and the temperature in the autoclave was raised to 70° C. Then, ethylene was added so that the partial pressure thereof might become 1.6 MPa, and the system was stabilized. As a result of gas chromatographic analysis, the gas composition in the system was as follows: hydrogen=0.08 mol %. 0.9 ml of a solution of triisobutyl aluminum in hexane (concentration: 1 mol/L) as the organoaluminum compound (C) was added thereto. Then, 1 ml of a solution of dimethylsilylenebis(3-phenylcyclopentadienyl)zirconiumdichloride (A) (racemic/meso ratio=49.2/50.8) in toluene (concentration: 1 μmol/ml) was added, and 15.8 mg of the solid catalyst component obtained in the above Example 1 (1) was added. While an ethylene/hydrogen mixed gas (hydrogen=0.05 mol %) was continuously fed during polymerization, ethylene and 1-hexene were copolymerized at 70° C. for 80 minutes. After that, butane, ethylene and hydrogen were purged to obtain 192 g of an ethylene-1-hexene copolymer. The obtained copolymer was kneaded with a roll so as to obtain a uniform copolymer, and its properties were evaluated. The result of the properties evaluation of the kneaded and obtained copolymer (hereinafter referred to as PE (1)) was shown in Table 3.

### (3) Molding of Cross-Linked Foam

100 parts by weight of the above PE (1), and 20 parts by weight of azodicarbonamide <ADCA> of the thermally decomposable foaming agent (CELLMIC CE, manufactured by Sankyo Kasei Co., Ltd, decomposition temperature: 208° C.), 1.5 parts by weight of zinc stearate and 0.5 part by weight of a hindered phenol-based antioxidant (IRGANOX 1010, manufactured by Ciba Japan K.K.), relative to 100 parts by weight of the PE (1) pellet, were kneaded at a number of revolutions of 25 rpm with a brabender set at about 120° C. to obtain a kneaded product. The kneaded product was put into a mold on a press set at 130° C., and heated for 15 minutes. The heated product was pressurized at about 5 MPa at 130° C., and then the heated and pressurized product was cooled to obtain a uncross-linked and unfoamed sheet having a thickness of 2 mm. Ionizing radiation was applied to the sheet so that the application amount might become 30 kGy at 800 kv with an electron beam accelerator, and thereby a cross-linked and unfoamed sheet was obtained. The cross-linked sheet was heated in an oven at 220° C. to obtain a cross-linked foam. The properties of the obtained cross-linked foam were shown in Table 4.

### Example 2

### (1) Polymerization

After reduced-pressure drying, an argon-substituted autoclave (inner volume of 3 L) with a stirrer was evacuated, to which hydrogen was added so that the partial pressure thereof might become 0.001 MPa. 60 ml of 1-hexene and 650 g of butane as a polymerization solvent were added thereto, and the temperature in the autoclave was raised to 70° C. Then, ethylene was added so that the partial pressure thereof might become 1.6 MPa, and the system was stabilized. As a result of gas chromatographic analysis, the gas composition in the system was as follows: hydrogen=0.06 mol %. 0.9 ml of a solution of triisobutyl aluminum in hexane (concentration: 1 mol/L) as the organoaluminum compound (C) was added to the autoclave. Then, 1 ml of a solution of dimethylsilylenebis(3-phenylcyclopentadienyl)zirconiumdichloride (A) (racemic/meso ratio=49.2/50.8) in toluene (concentration: 1 μmol/ml) was added, and 13.0 mg of the solid catalyst component obtained in the above Example 1 (1) was added. While an ethylene/hydrogen mixed gas (hydrogen=0.05 mol %) was continuously fed during polymerization, ethylene and 1-hexene were copolymerized at 70° C. for 60 minutes. After that, butane, ethylene and hydrogen were purged to obtain 37 g of an ethylene-1-hexene copolymer. The obtained copolymer was roll-kneaded in the same manner as in Example 1. The result of the properties evaluation of the kneaded and obtained copolymer (hereinafter referred to as PE (2)) was shown in Table 3.

### (2) Molding of Cross-Linked Foam

A cross-linked foam was obtained in the same manner as in Example 1, except that the PE (2) was used instead of the PE (1). The properties of the obtained cross-linked foam were shown in Table 4.

### Example 3

### (1) Polymerization

After reduced-pressure drying, an argon-substituted autoclave (inner volume of 3 L) with a stirrer was evacuated, to which 140 ml of 1-hexene and 650 g of butane as a polymerization solvent were added, and the temperature in the autoclave was raised to 65° C. Then, ethylene was added so that the partial pressure thereof might become 1.6 MPa, and the system was stabilized. 0.9 ml of a solution of triisobutyl aluminum in hexane (concentration: 1 mol/L) as the organoaluminum compound (C) was added to the autoclave. Then, 1 ml of a solution of dimethylsilylenebis(3-phenylcyclopentadienyl)zirconiumdichloride (A) (racemic/meso ratio=49.2/50.8) in toluene (concentration: 1 μmol/ml) was added, and 36 mg of the solid catalyst component obtained in the above Example 1 (1) was added. While an ethylene gas was continuously fed during polymerization, ethylene and 1-hexene were copolymerized at 65° C. for 60 minutes. After that, butane and ethylene were purged to obtain 193 g of an ethylene-1-hexene copolymer. The obtained copolymer was roll-kneaded in the same manner as in Example 1. The result of the properties evaluation of the kneaded and obtained copolymer (hereinafter referred to as PE (3)) was shown in Table 3.

### (2) Molding of Cross-Linked Foam

A cross-linked foam was obtained in the same manner as in Example 1, except that the PE (3) was used instead of the PE (1). The properties of the obtained cross-linked foam were shown in Table 4.

### Comparative Example 1

### (1) Prepolymerization

To a reactor (inner volume of 210 L) with a stirrer, substituted with nitrogen in advance, 80 L of butane was added at room temperature, and then 32.4 mmol of racemic-ethylenebis(1-indenyl)zirconiumphenoxide was added. After that, the temperature in the reactor was raised to 50° C., the mixture was stirred for 2 hours. The temperature in the reactor was lowered to 30° C., and 0.1 kg of ethylene, and hydrogen in an amount corresponding to 0.1 L of hydrogen under normal temperature and normal pressure were added thereto. Then, 697 g of the solid catalyst component prepared in the same manner as the method described in Example 1 (1) was added. After that, 2.59 mmol of diphenylmethylene(cyclopentadienyl)(9-fluorenyl)zirconiumdichloride dissolved in 300 ml of toluene was added. After stabilizing the system, 140 mmol of triisobutylaluminum was added to initiate ethylene polymerization.

First, ethylene was polymerized at a polymerization temperature in the reactor of 30° C. for 0.5 hour, the temperature in the reactor was raised to 50° C. over 30 minutes, and ethylene was polymerized at 50° C. For the first 0.5 hour, ethylene was fed at 0.6 kg/hour and hydrogen was fed in an amount corresponding to 0.7 L/hour of hydrogen under normal temperature and normal pressure. After the first 0.5 hour from initiating the polymerization, ethylene was fed at 3.2 kg/hour and hydrogen was fed in an amount corresponding to 9.6 L/hour of hydrogen under normal temperature and normal pressure. Prepolymerization was carried out for a total of 6 hours. After completion of the polymerization, the pressure in the reactor was purged to 0.6 MPaG, the obtained slurry prepolymerized catalyst component was transferred to a drier, and dried under a stream of nitrogen to obtain a prepolymerized catalyst component. The amount of the prepolymerized ethylene polymer in the prepolymerized catalyst component was 21.3 g per gram of the solid catalyst component, and the bulk density of the prepolymerized catalyst component was 461 kg/m³.

### (2) Gas Phase Polymerization

With a continuous fluidized bed gas phase polymerization apparatus, under conditions of a polymerization temperature of 86° C., a pressure of 2.0 MPaG, a holdup amount of 80 kg, a gas composition of ethylene 85.9 mol %, hydrogen 1.11 mol %, 1-hexene 1.39 mol % and nitrogen 11.5 mol %, a circulating gas linear velocity of 0.34 m/s, a feeding amount of the prepolymerized catalyst component obtained in the above (1) of 96.1 g/hour, and a feeding amount of triisobutylaluminum of 20 mmol/hour, ethylene and 1-hexene were copolymerized to obtain ethylene-1-hexene copolymer particles at a formation rate of 19.6 kg/hour. The obtained ethylene-1-hexene copolymer particles were granulated with an extruder (LCM 50, manufactured by Kobe Steel, Ltd.) under conditions of a feed rate of 50 kg/hour, a screw revolution number of 450 rpm, a gate opening degree of 50%, a suction pressure of 0.1 MPa, and a resin temperature of 200 to 230° C., and thereby an ethylene-1-hexene copolymer (hereinafter referred to as PE (4)) was obtained. The result of the properties evaluation using the obtained ethylene-1-hexene copolymer was shown in Table 3.

### (3) Molding of Cross-Linked Foam

A cross-linked foam was obtained in the same manner as in Example 1, except that the PE (4) was used instead of the PE (1). The properties of the obtained cross-linked foam were shown in Table 4.

### Comparative Example 21

### (1) Polymerization

After reduced-pressure drying, an argon-substituted autoclave (inner volume of 3 L) with a stirrer was evacuated, to which 180 ml of 1-hexene and 650 g of butane as a polymerization solvent were added, and the temperature in the autoclave was raised to 70° C. Then, ethylene was added so that the partial pressure thereof might become 1.6 MPa, and the system was stabilized. 0.9 ml of a solution of triisobutyl aluminum in hexane (concentration: 1 mol/L) as the organoaluminum compound (C) was added to the autoclave. Then, 3 ml of a solution of dimethylsilanediylbis(cyclopentadienyl)zirconiumdichloride in toluene (concentration: 2 μmol/ml) and 0.1 ml of a solution of diphenylmethylene(cyclopentadienyl)(9-fluorenyl)zirconiumdichloride in toluene (concentration: 1 μmol/ml) were added, and then 62.4 mg of the solid catalyst component obtained in the above Example 1 (1) was added. While an ethylene/hydrogen mixed gas (hydrogen=0.0758 mol %) was continuously fed during polymerization, ethylene and 1-hexene were copolymerized at 70° C. for 60 minutes. After that, butane, ethylene and hydrogen were purged to obtain an ethylene-1-hexene copolymer. The obtained copolymer was roll-kneaded in the same manner as in Example 1. The result of the properties evaluation of the kneaded and obtained copolymer (hereinafter referred to as PE (5)) was shown in Table 3.

### (2) Molding of Cross-Linked Foam

A cross-linked foam was obtained in the same manner as in Example 1, except that the PE (5) was used instead of the PE (1). The properties of the obtained cross-linked foam were shown in Table 4.

### Comparative Example 31

### (1) Gas Phase Polymerization

Using the prepolymerized catalyst component obtained in the above Comparative Example 1 (1), with a continuous fluidized bed gas phase polymerization apparatus, ethylene, 1-butene and 1-hexene were copolymerized to obtain copolymer powders. Polymerization conditions were as follows: a polymerization temperature of 81.4° C., a polymerization pressure of 2 MPa, a molar ratio of hydrogen to ethylene of 1.82%, a molar ratio of 1-butene to the total of ethylene, 1-butene and 1-hexene of 2.46%, and a molar ratio of 1-hexene to the total of ethylene, 1-butene and 1-hexene of 0.76%. Ethylene, 1-butene, 1-hexene and hydrogen were continuously fed so as to maintain a constant gas composition during polymerization. In addition, the above prepolymerized catalyst component and triisobutylaruminum were continuously fed, and thereby a total weight of powders in the fluidized bed was maintained at 80 kg. The average polymerization time was 4 hours. The obtained copolymer powders were granulated with an extruder (LCM 50, manufactured by Kobe Steel, Ltd.) under conditions of a feed rate of 50 kg/hour, a screw revolution number of 450 rpm, a gate opening degree of 50%, a suction pressure of 0.1 MPa, and a resin temperature of 200 to 230° C., and thereby an ethylene-1-hexene-1-butene copolymer (hereinafter referred to as PE (6)) was obtained. The result of the properties evaluation of the obtained copolymer was shown in Table 3.

### (2) Molding of Cross-Linked Foam

A cross-linked foam was obtained in the same manner as in Example 1, except that the PE (6) was used instead of the PE (1). The properties of the obtained cross-linked foam were shown in Table 4.

TABLE 3

| | | | | | Comparative | Comparative | Comparative |
|---|---|---|---|---|---|---|---|
| | | Example 1 | Example 2 | Example 3 | Example 1 | Example 2 | Example 3 |
| | | PE (1) | PE (2) | PE (3) | PE (4) | PE (5) | PE (6) |
| Density | kg/m³ | 920 | 923 | 914 | 918 | 926 | 920 |
| MFR | g/10 min | 2.1 | 3.4 | 0.9 | 4.6 | 0.8 | 1.7 |
| MFRR | — | 55 | 46 | 66 | 49 | 86 | 77 |
| SR | — | 1.78 | 1.79 | 1.91 | 1.72 | 1.92 | 1.48 |
| N_{LCB} | 1/1000 C. | 0.29 | 0.35 | 0.29 | 0.19 | 0.16 | 0.23 |
| Molecular | — | 5.2 | 6.3 | 5.4 | 6.7 | 14.1 | 8.4 |
| Weight | | | | | | | |
| Distribution | | | | | | | |
| Mw/Mn | | | | | | | |
| Ea | kJ/mol | 62 | 57 | 72 | 56 | 36 | 72 |
| g* | — | 0.73 | 0.72 | 0.77 | 0.83 | 0.79 | 0.79 |
| k | — | 0.84 | 0.84 | 0.80 | 0.51 | 1.09 | 0.63 |
| MT | cN | 7.0 | 4.6 | 19.9 | 3.2 | 31.0 | 4.0 |

TABLE 4

| Composition | | | | | Comparative | Comparative | Comparative |
|---|---|---|---|---|---|---|---|
| (parts by weight) | | Example 1 | Example 2 | Example 3 | Example 1 | Example 2 | Example 3 |
| PE (1) | | 100 | | | | | |
| PE (2) | | | 100 | | | | |
| PE (3) | | | | 100 | | | |
| PE (4) | | | | | 100 | | |
| PE (5) | | | | | | 100 | |
| PE (6) | | | | | | | 100 |
| Thermally | | 20 | 20 | 20 | 20 | 20 | 20 |
| decomposable | | | | | | | |
| foaming agent | | | | | | | |
| (ADCA) | | | | | | | |
| Application | kGy | 30 | 30 | 30 | 30 | 30 | 30 |
| amount of | | | | | | | |
| ionizing radiation | | | | | | | |
| Foam density | kg/m³ | 28.9 | 29.8 | 27.6 | 32.8 | 27.5 | 264 |
| Expansion ratio | fold | 32 | 31 | 33 | 28 | 34 | 3.5 |
| Tensile impact | kJ/m² | 1.67 | 0.93 | 2.93 | 0.48 | 0.25 | —* |
| strength | | | | | | | |

—* not determined

The cross-linked foams, obtained by applying ionizing radiation to the resin compositions of the present invention comprising the ethylene-α-olefin copolymer and the thermally decomposable foaming agent and heating them, are excellent in an expansion ratio and strength.

### Example 4

### (1) Polymerization

After reduced-pressure drying, an argon-substituted autoclave (inner volume of 3 L) with a stirrer was evacuated, to which 160 ml of 1-hexene and 650 g of butane as a polymerization solvent were added, and the temperature in the autoclave was raised to 70° C. Then, ethylene was added so that the partial pressure thereof might become 2.0 MPa, and the system was stabilized. 0.9 ml of a solution of triisobutyl aluminum in hexane (concentration: 1 mol/L) as the organoaluminum compound (C) was added thereto. Then, 1 ml of a solution of dimethylsilylenebis(3-phenylcyclopentadienyl)zirconiumdichloride (A) (racemic/meso ratio=49.2/50.8) in toluene (concentration: 1 μmol/ml) was added, and 15.3 mg of the solid catalyst component obtained in the above Polymerization Example 1 (1) was added. While an ethylene gas was continuously fed during polymerization, ethylene and 1-hexene were polymerized at 65° C. for 60 minutes. After that, butane and ethylene were purged to obtain an ethylene-1-hexene copolymer. The same polymerization step was repeated five times, and then a total amount of 466 g of an ethylene-1-hexene copolymer was obtained. The copolymer obtained by the five-times-polymerization was roll-kneaded in the same manner as in Polymerization Example 1 so as to obtain a uniform copolymer. The result of the properties evaluation of the kneaded and obtained copolymer (hereinafter referred to as PE (7)) was shown in Table 5.

TABLE 5

| | | | Comparative | Comparative |
|---|---|---|---|---|
| | | Example 4 | Example 4 | Example 5 |
| | | PE (7) | PE (8) | PE (9) |
| Density | kg/m³ | 912 | 908 | 912 |
| MFR | g/10 min | 0.4 | 0.1 | 0.5 |
| MFRR | — | 81 | 107 | 99 |
| SR | — | 1.62 | 1.34 | 1.37 |
| N_{LCB} | 1/1000 C. | 0.33 | 0.20 | 0.21 |
| Molecular | — | 5.4 | 7.9 | 8.7 |
| Weight | | | | |
| Distribution | | | | |
| Mw/Mn | | | | |
| Ea | kJ/mol | 67 | 62 | 80 |
| g* | — | 0.73 | 0.83 | 0.82 |
| k | — | 00 | 00 | — |
| MT | cN | 23.5 | 14.0 | 6.5 |

—: not determined

### (2) Foaming

60 parts by weight of the ethylene-1-hexene copolymer PE (7) obtained by the polymerization in Example 4 and 40 parts by weight of the ethylene-vinyl acetate copolymer (COSMOTHENE H2181 [MFR=2 g/10 minutes, density=940 kg/m³, amount of vinyl acetate units=18% by weight], manufactured by The Polyolefine Company; hereinafter referred to as EVA (1)), and 10 parts by weight of heavy calcium carbonate, 1.0 parts by weight of stearic acid, 1.0 parts by weight of zinc oxide, 4.9 parts by weight of the thermally decomposable foaming agent (CELLMIC CE, manufactured by Sankyo Kasei Co., Ltd) and 0.7 part by weight of dicumyl peroxide, relative to 100 parts by weight of a total amount of the PE (7) and the EVA (1), were kneaded with a roll kneading machine under conditions of a roll temperature of 120° C. and a kneading time of 5 minutes, and thereby a resin composition was obtained. The resin composition was put into a 15 cm×15 cm×2.0 cm mold to obtain a cross-linked foam by foaming the resin composition under conditions of a temperature of 165° C., a time of 30 minutes and a pressure of 150 kg/cm². The result of the properties evaluation of the obtained cross-linked foam was shown in Table 6.

### Comparative Example 4

### (1) Prepolymerization

To a reactor (inner volume of 210 L) with a stirrer, substituted with nitrogen in advance, 80 L of butane was added at room temperature, and then 32.4 mmol of racemic-ethylenebis(1-indenyl)zirconiumphenoxide was added. After that, the temperature in the reactor was raised to 50° C., the component in the reactor was stirred for 2 hours. The temperature in the reactor was lowered to 30° C., and 0.1 kg of ethylene, and hydrogen in an amount corresponding to 0.1 L of hydrogen under normal temperature and normal pressure were added thereto. Then, 697 g of the particulate solid catalyst component prepared in the same manner as the method described in Examples 1 (1) and (2) of JP-A-2009-79182 was added. After that, 2.59 mmol of diphenylmethylene(cyclopentadienyl)(9-fluorenyl)zirconiumdichloride dissolved in 300 ml of toluene was added. After stabilizing the system, 140 mmol of triisobutylaluminum was added to initiate ethylene polymerization.

After the initiation of ethylene polymerization, the operation was carried out at a temperature in the reactor of 30° C. for 0.5 hour. The temperature was raised to 50° C. over 30 minutes, and after that, ethylene was polymerized at 50° C. For the first 0.5 hour, ethylene was fed at 0.6 kg/hour and hydrogen was fed in an amount corresponding to 0.7 L/hour of hydrogen under normal temperature and normal pressure. After the first 0.5 hour from initiating the polymerization, ethylene was fed at 3.2 kg/hour and hydrogen was fed in an amount corresponding to 9.6 L/hour of hydrogen under normal temperature and normal pressure. Ethylene was prepolymerized for a total of 6 hours. After completion of the polymerization, the pressure in the reactor was purged to 0.6 MPaG, the slurry prepolymerized catalyst component was transferred to a drier, and dried under a stream of nitrogen to obtain a prepolymerized catalyst component. The amount of the prepolymerized ethylene polymer in the prepolymerized catalyst component was 21.3 g per gram of the particulate solid catalyst component, and the bulk density of the prepolymerized catalyst component was 461 kg/m³.

### (2) Gas Phase Polymerization

Using the above prepolymerized catalyst component, with a continuous fluidized bed gas phase polymerization apparatus, ethylene and 1-hexene were copolymerized to obtain copolymer powders. Polymerization conditions were as follows: a polymerization temperature of 80° C., a polymerization pressure of 2 MPa, a molar ratio of hydrogen to ethylene of 0.46%, and a molar ratio of 1-hexene to the total of ethylene and 1-hexene of 1.9%. Ethylene, 1-hexene and hydrogen were continuously fed so as to maintain a constant gas composition during polymerization. In addition, the above prepolymerized catalyst component and triisobutylaruminum were continuously fed, and thereby a total weight of powders in the fluidized bed was maintained at 80 kg. The average polymerization time was 4 hours. The obtained ethylene-1-hexene copolymer particles were granulated with an extruder (LCM 50, manufactured by Kobe Steel, Ltd.) under conditions of a feed rate of 50 kg/hour, a screw revolution number of 450 rpm, a gate opening degree of 50%, a suction pressure of 0.1 MPa, and a resin temperature of 200 to 230° C., and thereby an ethylene-1-hexene copolymer (hereinafter referred to as PE (8)) was obtained. The properties of the obtained copolymer were shown in Table 5.

### (3) Foaming

60 parts by weight of the ethylene-α-olefin copolymer PE (8) obtained by the polymerization in Comparative Example 4 and 40 parts by weight of the EVA (1), and 10 parts by weight of heavy calcium carbonate, 1.0 parts by weight of stearic acid, 1.0 parts by weight of zinc oxide, 3.6 parts by weight of the thermally decomposable foaming agent (CELLMIC CE, manufactured by Sankyo Kasei Co., Ltd) and 0.7 part by weight of dicumyl peroxide, relative to 100 parts by weight of a total amount of the PE (8) and the EVA (1), were kneaded with a roll kneading machine under conditions of a roll temperature of 120° C. and a kneading time of 5 minutes, and thereby a resin composition was obtained. The resin composition was put into a 15 cm×15 cm×2.0 cm mold to obtain a cross-linked foam by foaming the resin composition under conditions of a temperature of 165° C., a time of 30 minutes and a pressure of 150 kg/cm². The result of the properties evaluation of the obtained cross-linked foam was shown in Table 6.

### Comparative Example 5

### (1) Preparation of Prepolymerized Catalyst Component

To an autoclave (inner volume of 210 L) with a stirrer, substituted with nitrogen in advance, 80 L of butane was added, and then 109 mmol of racemic-ethylenebis(1-indenyl)zirconiumphenoxide was added. The temperature in the autoclave was raised to 50° C., the component in the autoclave was stirred for 2 hours. After the temperature in the autoclave was lowered to 30° C. and the system was stabilized, ethylene was charged into the autoclave up to a vapor phase pressure of 0.03 MPa, to which 0.7 kg of the solid catalyst component (B) described in Example 1 was added and 158 mmol of triisobutylaluminum was subsequently added to initiate ethylene polymerization. After ethylene was continuously fed at a rate of 0.7 kg/hour for 30 minutes, the temperature in the autoclave was raised to 50° C., to which ethylene and hydrogen were continuously charged at a rate of 3.5 kg/hour and 10.2 L (in terms of volume at normal temperature and normal pressure)/hour, respectively, to polymerize ethylene for a total of 4 hours. After completion of the polymerization, ethylene, butane, hydrogen and the like were purged to leave a solid, which was dried under vacuum at room temperature to obtain a prepolymerized catalyst component in which 15 g of polyethylene per gram of the above solid catalyst component (B) was prepolymerized.

### (2) Preparation of ethylene-α-olefin copolymer

Using the above prepolymerized catalyst component, with a continuous fluidized bed gas phase polymerization apparatus, ethylene and 1-hexene were copolymerized to obtain copolymer powders. Polymerization conditions were as follows: a polymerization temperature of 80° C., a polymerization pressure of 2 MPa, a molar ratio of hydrogen to ethylene of 0.4%, and a molar ratio of 1-hexene to the total of ethylene and 1-hexene of 1.6%. Ethylene, 1-hexene and hydrogen were continuously fed so as to maintain a constant gas composition during polymerization. In addition, the above prepolymerized catalyst component and triisobutylaruminum were continuously fed, and thereby a total weight of powders in the fluidized bed was maintained at 80 kg. The average polymerization time was 4 hours. The obtained copolymer powders were granulated with an extruder (LCM 50, manufactured by Kobe Steel, Ltd.) under conditions of a feed rate of 50 kg/hour, a screw revolution number of 450 rpm, a gate opening degree of 50%, a suction pressure of 0.1 MPa, and a resin temperature of 200 to 230° C., and thereby an ethylene-1-hexene copolymer (hereinafter referred to as PE (9)) was obtained. The properties of the obtained copolymer were shown in Table 5.

### (3) Foaming

60 parts by weight of the ethylene-α-olefin copolymer PE (9) obtained by the polymerization in Comparative Example 5 and 40 parts by weight of the EVA (1), and 10 parts by weight of heavy calcium carbonate, 1.0 parts by weight of stearic acid, 1.0 parts by weight of zinc oxide, 3.3 parts by weight of the thermally decomposable foaming agent (CELLMIC CE, manufactured by Sankyo Kasei Co., Ltd) and 0.7 part by weight of dicumyl peroxide, relative to 100 parts by weight of a total amount of the PE (9) and the EVA (1), were kneaded with a roll kneading machine under conditions of a roll temperature of 120° C. and a kneading time of 5 minutes, and thereby a resin composition was obtained. The resin composition was put into a 15 cm×15 cm×2.0 cm mold to obtain a cross-linked foam by foaming the resin composition under conditions of a temperature of 165° C., a time of 30 minutes and a pressure of 150 kg/cm². The result of the properties evaluation of the obtained cross-linked foam was shown in Table 6.

TABLE 6

| | | | Comparative | Comparative |
|---|---|---|---|---|
| | | Example 4 | Example 4 | Example 5 |
| Resin | | | | |
| composition | | | | |
| PE(7) | parts by weight | 60 | 0 | 0 |
| PE(8) | parts by weight | 0 | 60 | 0 |
| PE(9) | parts by weight | 0 | 0 | 60 |
| EVA1 | parts by weight | 40 | 40 | 40 |
| Termally | parts by weight | 4.9 | 3.6 | 3.3 |
| decomposable | | | | |
| foaming agent | | | | |
| Properties of | | | | |
| cross-linked | | | | |
| foam | | | | |
| Foam density | [kg/m³] | 90 | 110 | 105 |
| Skin-off | [shoreC] | 45 | 45 | 43 |
| hardness | | | | |
| Compression | [%] | 61 | 62 | 68 |
| set | | | | |

The cross-linked foam obtained by cross-linking the polymer with the organic peroxide is suitable as members for footwear. When a cross-linked foam is used as members for footwear, it is necessary that its hardness is around 30 to 60 and is adapted in a product. In addition to meeting these requirements, the cross-linked foam having a low density and a low compression set is required. The organic peroxide cross-linked foam, obtained by cross-linking and foaming the resin composition of the present invention comprising the ethylene-α-olefin copolymer, the thermally decomposable foaming agent and the organic peroxide, has a low density and a low compression set, as compared with the cross-linked foams of the Comparative Examples having the same hardness as that of the cross-linked foam of the present invention. The organic peroxide cross-linked foam, obtained by cross-linking and foaming the resin composition of the present invention comprising the organic peroxide, is suitable as members for footwear.

### INDUSTRIAL APPLICABILITY

The present invention can provide the ethylene-α-olefin copolymer for producing a foam and the resin composition for producing a foam, which can be preferably used in a variety of methods for producing foams.

1. An ethylene-α-olefin copolymer comprising monomer units derived from ethylene and monomer units derived from an α-olefin having 3 to 20 carbon atoms for producing a foam, wherein the ethylene-α-olefin copolymer has a melt flow rate of 0.1 to 100 g/10 minutes, a density of 850 to 940 kg/m³, a molecular weight distribution of 2 to 12, a swell ratio of 1.61 or more, and a value of g* defined by the following formula (I) of 0.50 to 0.78:
g*=[η]/([η]_{GPC}×g_{SCB}*) (I)
wherein [η] is the intrinsic viscosity (in dl/g) of the ethylene-α-olefin copolymer and is defined by the following formula (I-I), [η]_{GPC} is defined by the following formula (I-II), and g_{SCB}* is defined by the following formula (I-III):
[η]=23.3×log(ηrel) (I-I)
wherein ηrel is the relative viscosity of the ethylene-α-olefin copolymer,
[η]_{GPC}=0.00046×Mv^{0.725} (I-II)
wherein Mv is the viscosity average molecular weight of the ethylene-α-olefin copolymer,
g_{SCB}*=(1−A)^{1.725} (I-III)
wherein A is determined from the content of short branches in the ethylene-α-olefin copolymer.

2. A resin composition for producing a foam, wherein the resin composition comprises 100 parts by weight of a resin material comprising the ethylene-α-olefin copolymer according to claim 1 and 1 to 80 parts by weight, relative to 100 parts by weight of the resin material, of a thermally decomposable foaming agent, wherein the thermally decomposable foaming agent has a decomposition temperature of 120 to 240° C.

3. The resin composition according to claim 2, wherein the resin composition further comprises 0.02 to 3 parts by weight, relative to 100 parts by weight of the resin material, of an organic peroxide.

4. A method for producing a cross-linked foam, wherein the method comprises the following steps:
a step of applying ionizing radiation to the resin composition according to claim 2 to form a cross-linked intermediate (i), and
a step of expanding the cross-linked intermediate (i) by heating the cross-linked intermediate (i) to form a cross-linked foam.

5. A method for producing a cross-linked foam, wherein the method comprises the following steps:
a step of feeding the resin composition according to claim 3 into a mold,
a step of pressurizing and heating the resin composition in the mold to form a plasticized and cross-linked intermediate (ii), and
a step of expanding the intermediate (ii) by opening the mold to form a cross-linked foam.

6. A method for producing a cross-linked foam, wherein the method comprises the following steps:
a step of pressurizing and heating the resin composition according to claim 3 to form a plasticized intermediate (iii),
a step of feeding the plasticized intermediate (iii) into a mold and cross-linking the intermediate (iii) by pressurizing and heating the intermediate (iii) in the mold to form a plasticized and cross-linked intermediate (iv), and
a step of expanding the intermediate (iv) by opening the mold to form a cross-linked foam.

7. A method for producing a cross-linked foam, wherein the method comprises the following steps:
a step of applying ionizing radiation to the resin composition according to claim 3 to form a cross-linked intermediate (i), and
a step of expanding the cross-linked intermediate (i) by heating the cross-linked intermediate (i) to form a cross-linked foam.
